(19) United States
(12) Patent Application Publication
(10) Pub. No.: US 2026/0126565 A1
(43) Pub. Date: May 7, 2026

(54) HARDENED OPTICAL WINDOWS WITH ANTI-REFLECTIVE FILMS HAVING LOW VISIBLE REFLECTANCE AND TRANSMISSION FOR INFRARED SENSING SYSTEMS

(71) Applicant: CORNING INCORPORATED, CORNING, NY (US)

(72) Inventors: Casey James Gonta, Painted Post, NY (US); Joshua Michael Jacobs, Corning, NY (US); Rui Luo, Fremont, CA (US); Chuan Ni, Shanghai (CN); Sang Ki Park, Painted Post, NY (US)

(21) Appl. No.: 19/117,478

(22) PCT Filed: Oct. 7, 2023
(86) PCT No.: PCT/CN2023/123249

§ 371 Date: Apr. 1, 2025

Related U.S. Application Data
(60) Provisional application No. 63/414,128, filed on Oct. 7, 2022.
(60) Provisional application No. 63/525,029, filed on Jul. 5, 2023.

(51) Int. Cl. G02B 1/14; G01S 17/88

(52) U.S. Cl. CPC G02B 1/14; G01S 17/88

(57) ABSTRACT

Described herein is a window (24) comprising first and second layered films (36.38). The window (24) exhibits a maximum hardness, measured at the first layered film (36) and by the Berkovich Indenter Hardness Test. of at least 8 GPa to facilitate durability and scratch resistance. The quantity, the thicknesses, number, and materials of alternating layers of the first and second layered films (36,38) are configured so that the window (24) has a relatively high transmittance (e.g., greater than 90%) and low reflectance (e.g., less than 5%) over a 50 nm wavelength range of interest centered at a wavelength between 850 nm and 950 nm, while still exhibiting a dark, opaque appearance when the window (24) is viewed from the first layered film (36).

### CROSS-REFERENCE TO RELATED APPLICATIONS

This application claims the benefit of priority under 35 U.S.C. § 119 of U.S. Provisional Application Ser. No. 63/414,128 filed on Oct. 7, 2022, and U.S. Provisional Application Ser. No. 63/525,029 filed on Jul. 5, 2023, the contents of which are relied upon and incorporated herein by reference in their entirety.

### FIELD OF THE DISCLOSURE

The present disclosure relates to protective covers for sensor systems. Particularly, the present disclosure relates to protective covers including layered films so that the protective cover exhibits antireflective properties over a 50 nm wavelength of interest from 850 nm to 850 nm while exhibiting a dark, opaque appearance.

### BACKGROUND

Light detection and ranging (“LIDAR”) systems include an electromagnetic radiation emitter and a sensor. The electromagnetic radiation emitter emits an electromagnetic radiation emitter beam, which may reflect off an object, and the sensor detects the reflected electromagnetic radiation emitter beam. The electromagnetic radiation emitter beams can be continuous wave, pulsed, frequency modulated, or otherwise distributed across a radial range to detect objects across a field of view. Information about the object can be deciphered from the properties of the detected reflected electromagnetic radiation emitter beam. Distance of the object from the electromagnetic radiation emitter beam can be determined from the time of flight from emission of the electromagnetic radiation emitter beam to detection of the reflected electromagnetic radiation emitter beam. If the object is moving, path and velocity of the object can be determined from shifts in radial position of the emitted electromagnetic radiation emitter beam being reflected and detected as a function of time, as well as from Doppler frequency measurements in some cases.

LIDAR systems in automobiles, and other infrared sensing systems in exposed environments, such as aerospace or home security applications, need to be protected from the environment and various sources of damage, for example, with a covering lens or cover glass window. Vehicles are another potential application for LIDAR systems, with the LIDAR systems providing spatial mapping capability to enable assisted, semi-autonomous, or fully autonomous driving. In such applications, the electromagnetic radiation emitter and sensor are mounted on the roof of the vehicle or on a low forward portion of the vehicle. Electromagnetic radiation emitters emitting electromagnetic radiation having a wavelength outside the range of visible light, such as at 905 nm or 1550 nm are considered for vehicle LIDAR applications. To protect the electromagnetic radiation emitter and sensor from impact from rocks and other objects, a window is placed between the electromagnetic radiation emitter and sensor, and the external environment in the line of sight of the electromagnetic radiation emitter and sensor. A window is similarly placed between the electromagnetic radiation emitter/sensor and the external environment for other applications of the LIDAR system, such as aerospace and home security applications. However, there is a problem in that rocks and other objects impacting the window scratch and cause other types of damage to the window, which cause the window to scatter the emitted and reflected electromagnetic radiation emitter beams, thus impairing the effectiveness of the LIDAR system.

### SUMMARY

The present disclosure solves that problem with a window that includes first and second layered films. The first layered film may face away from an electromagnetic radiation emitter/sensor when installed in a LIDAR system and include a scratch resistant layer embedded therein to provide damage resistance to the window. Thus, rocks and other objects impacting the window are less likely to cause defects to the window that scatter the emitted and reflected electromagnetic radiation from the LIDAR sensor, resulting in improved performance. In addition, the first and second layered films further include alternating layers of materials having different indices of refraction (including the material providing the hardness and scratch resistance), such that the number of alternating layers and their thicknesses can be configured so that the window has high transmissivity and low reflection in a desired wavelength range (e.g., over a 50 nm wavelength range about a center wavelength between 850 nm and 950 nm). The alternating layers of material may be further selected such that the window transmits and reflects relatively low amounts of radiation in the visible spectrum, thereby providing the window with aesthetically pleasing dark appearance while diminishing signal noise caused by visible light that may otherwise impinge on a detector of a LIDAR system.

An aspect (1) of the present disclosure pertains to a window for a sensing system comprising: a substrate comprising a first surface and a second surface, the first surface and the second surface being primary surfaces of the substrate; a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film; a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and a maximum hardness, measured at the first layered film and by the Berkovich Indenter Hardness Test, of at least 8 GPa, wherein the quantity, the thicknesses, number, and materials of the alternating layers of the first and second layered films are configured so that the window has: an average percentage transmittance, calculated over a 50 nm wavelength range of interest centered at a wavelength between 850 nm and 950 nm, of greater than 90% for light incident on the first surface and the second surface at angles of incidence of less than or equal to 15°; an average reflectance, calculated over the 50 nm wavelength range of interest between 850 nm and 950 nm, of less than 4% for light incident on the first surface and the second surface at angles of less than or equal to 15°; and an average percentage transmission, calculated from 400 nm to 700 nm, of less than 5% for light incident on the first surface and the second surface at angles of incidence of less than or equal to 15°.

An aspect (2) of the present disclosure pertains to a window according to the aspect (1), wherein the quantity, the thicknesses, number, and materials of the alternating layers of the first and second layered films are configured so that the window has an average P polarization transmittance and an average S polarization transmittance, calculated over the 50 nm wavelength range of interest, of greater than 85% for light incident on the first surface and the second surface at angles of incidence of less than or equal to 60°.

An aspect (3) of the present disclosure pertains to a window according to the aspect (2), wherein the average P polarization transmittance and the average S polarization transmittance, calculated over the 50 nm wavelength range of interest, are greater than 89% for light incident on the first surface and the second surface at angles of incidence of less than or equal to 60°.

An aspect (4) of the present disclosure pertains to a window according to any of the aspects (1)-(3), wherein the quantity, the thicknesses, number, and materials of the alternating layers of the first and second layered films are configured so that the window has a CIELAB L* value for reflection of less than or equal to 37 for angles of incidence of less than or equal to 60° on the first layered film.

An aspect (5) of the present disclosure pertains to a window according to the aspect (4), wherein the CIELAB L* value for reflection is less than or equal to 25 for angles of incidence of less than or equal to 50° on the first layered film.

An aspect (6) of the present disclosure pertains to a window according to any of the aspects (1)-(5), wherein the quantity, the thicknesses, number, and materials of the alternating layers of the first and second layered films are configured so that the window has CIELAB a* and b* values for reflection of greater than or equal to −6.0 and less than or equal to 6.0 when viewed from a side of the first layered film.

An aspect (7) of the present disclosure pertains to a window according to any of the aspects (1)-(6), wherein the quantity, the thicknesses, number, and materials of the alternating layers of the first and second layered films are configured so that the window has an average percentage transmittance, calculated over the 50 nm wavelength range of interest, of greater than 95% for light normally incident on the first surface and the second surface.

An aspect (8) of the present disclosure pertains to a window according to any of the aspects (1)-(7), wherein: the refractive index of the substrate for electromagnetic radiation having a wavelength of 905 nm is from about 1.45 to about 1.55, the substrate is a glass substrate or a glass-ceramic substrate, the refractive index of the one or more higher refractive index materials is from about 1.7 to about 4.0, and wherein the refractive index of the one or more lower refractive index materials is from about 1.3 to about 1.6, and a difference in the refractive index of any of the one or more higher refractive index materials and any of the one or more lower refractive index materials is about 0.5 or greater.

An aspect (9) of the present disclosure pertains to a window according to any of the aspects (1)-(8), wherein: one of the alternating layers of the first layered film that is farthest from the substrate forms a terminal surface material of the window, the terminal surface material of the window comprising the lower refractive index material, and the first layered firm comprises a scratch resistant layer formed of one of the one or more higher refractive index materials and having a thickness of greater than or equal to 1500 nm and less than or equal to 5000 nm.

An aspect (10) of the present disclosure pertains to a window according to the aspect (9), wherein the scratch resistant layer is separated from the terminal surface by a plurality of the alternating layers of the one or more lower index materials and the one or more higher index materials of the first layered film.

An aspect (11) of the present disclosure pertains to a window according to the aspect (10), wherein the scratch resistant layer is separated from the terminal surface by at least 1000 nm.

An aspect (12) of the present disclosure pertains to a window according to the aspect (1)-(11), wherein the one or more higher refractive index materials of the second layered film comprise silicon having an extinction coefficient of less than or equal to 0.01 over the 50 nm wavelength range of interest.

An aspect (13) of the present disclosure pertains to a window according to the aspect (12), wherein the extinction coefficient is less than or equal to 0.005 over the 50 nm wavelength range of interest.

An aspect (14) of the present disclosure pertains to a window according to the aspect (13), wherein the second layered film comprises two or more silicon layers.

An aspect (15) of the present disclosure pertains to a window according to the aspect (14), wherein a silicon layer of the second layered film most proximate to the substrate comprises the smallest thickness of the two or more silicon layers.

An aspect (16) of the present disclosure pertains to a window according to the aspect (15), wherein a combined thickness of the silicon layers contained in the second layered film is greater than or equal to 500 nm.

An aspect (17) of the present disclosure pertains to a window according to any of the aspects (12)-(16), wherein a layer of the one or more higher refractive index materials in the second layered film is not silicon.

An aspect (18) of the present disclosure pertains to a window according to any of the aspects (1)-(17), wherein the maximum hardness, measured at the first layered film and by the Berkovich Indenter Hardness Test, is at least 15 GPa.

An aspect (19) of the present disclosure pertains to a window according to any of the aspects (1)-(18), wherein a hardness, measured at the first layered film and by the Berkovich Indenter Hardness Test, is at least 14 GPa over a depth range of 400 nm to 1000 nm.

An aspect (20) of the present disclosure pertains to a window for a sensing system comprising: a substrate comprising a first surface and a second surface, the first surface and the second surface being primary surfaces of the substrate; a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film; a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and a maximum hardness, measured at the first layered film and by the Berkovich Indenter Hardness Test, of at least 8 GPa, wherein the quantity, the thicknesses, number, and materials of the alternating layers of the first and second layered films are configured so that the window has: an average reflectance, calculated over a 50 nm wavelength range of interest centered at a wavelength between 850 nm and 950 nm, of less than 4% for light incident on the first surface and the second surface at angles of less than or equal to 15°; a CIELAB L* value for reflection of less than or equal to 37 for angles of incidence of less than or equal to 60° on the first layered film; and CIELAB a* and b* values for reflection of greater than or equal to −6.0 and less than or equal to 6.0 when viewed from a side of the first layered film.

An aspect (21) of the present disclosure pertains to a window according to the aspect (20), wherein the CIELAB L* value for reflection is less than or equal to 25 for angles of incidence of less than or equal to 50° on the first layered film.

An aspect (22) of the present disclosure pertains to a window according to any of the aspects (20)-(21), wherein the quantity, the thicknesses, number, and materials of the alternating layers of the first and second layered films are configured so that the window has an average percentage transmittance, calculated over the 50 nm wavelength range of interest, of greater than 95% for light incident on the first surface and the second surface at angles of incidence of less than or equal to 15°.

An aspect (23) of the present disclosure pertains to a window according to any of the aspects (20)-(22), wherein the quantity, the thicknesses, number, and materials of the alternating layers of the first and second layered films are configured so that the window has an average percentage transmission, calculated from 400 nm to 700 nm, of less than 5% for light incident on the first surface and the second surface at angles of incidence of less than or equal to 15°.

An aspect (24) of the present disclosure pertains to a window according to any of the aspects (20)-(23), wherein the quantity, the thicknesses, number, and materials of the alternating layers of the first and second layered films are configured so that the window has an average P polarization transmittance and an average S polarization transmittance, calculated over the 50 nm wavelength range, of greater than 85% for light incident on the first surface and the second surface at angles of incidence of less than or equal to 60°.

An aspect (25) of the present disclosure pertains to a window according to the aspect (24), wherein the average P polarization transmittance and the average S polarization transmittance, calculated over the 50 nm wavelength range of interest, are greater than 89% for light incident on the first surface and the second surface at angles of incidence of less than or equal to 60°.

An aspect (26) of the present disclosure pertains to a window according to any of the aspects (20)-(25), wherein the maximum hardness, measured at the layered film and by the Berkovich Indenter Hardness Test, is at least 15 GPa.

An aspect (27) of the present disclosure pertains to a window according to any of the aspects (20)-(26), wherein: one of the alternating layers of the first layered film that is farthest from the substrate forms a terminal surface material of the window, the terminal surface material of the window comprising the lower refractive index material, the first layered firm comprises a scratch resistant layer formed of one of the one or more higher refractive index materials and having a thickness that is greater than or equal to 1500 nm and less than or equal to 5000 nm.

An aspect (28) of the present disclosure pertains to a window according to the aspect (27), wherein: the scratch resistant layer is separated from the terminal surface by a plurality of the alternating layers of the one or more lower index materials and the one or more higher index materials of the first layered film, and the scratch resistant layer is separated from the terminal surface by at least 1000 nm.

An aspect (29) of the present disclosure pertains to a window according to any of the aspects (20)-(28), wherein the one or more higher refractive index materials of the second layered film comprise silicon having an extinction coefficient of less than or equal to 0.004 over the 50 nm wavelength range of interest.

An aspect (30) of the present disclosure pertains to a window according to the aspect (29), wherein the second layered film comprises two or more silicon layers.

An aspect (31) of the present disclosure pertains to a window according to the aspect (30), wherein a silicon layer of the second layered film most proximate to the substrate comprises the smallest thickness of the two or more silicon layers.

An aspect (32) of the present disclosure pertains to a window according to the aspect (31), wherein a combined thickness of the silicon layers contained in the second layered film is greater than or equal to 500 nm.

An aspect (33) of the present disclosure pertains to a window according to any of the aspects (29)-(32), wherein a layer of the one or more higher refractive index materials in the second layered film is not silicon.

An aspect (34) of the present disclosure pertains to a window for a sensing system comprising: a substrate comprising a first surface and a second surface, the first surface and the second surface being primary surfaces of the substrate; a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film; a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film, wherein the one or more higher refractive index materials of the second layered film comprises silicon; and a maximum hardness, measured at the first layered film and by the Berkovich Indenter Hardness Test, of at least 15 GPa, wherein the quantity, the thicknesses, number, and materials of the alternating layers of the first and second layered films are configured so that the window has: an average reflectance, calculated over a 50 nm wavelength range of interest centered at a wavelength between 850 nm and 950 nm, of less than 4% for light incident on the first surface and the second surface at angles of less than or equal to 15°; and an average percentage transmittance, calculated over the 50 nm wavelength range of interest, of greater than 95% for light incident on the first surface and the second surface at angles of incidence of less than or equal to 15°.

An aspect (35) of the present disclosure pertains to a window according to the aspect (34), wherein the quantity, the thicknesses, number, and materials of the alternating layers of the first and second layered films are configured so that the window has an average percentage transmission, calculated from 400 nm to 700 nm, of less than 5% for light incident on the first surface and the second surface at angles of incidence of less than or equal to 15°.

An aspect (36) of the present disclosure pertains to a window according to any of the aspects (34)-(35), wherein the quantity, the thicknesses, number, and materials of the alternating layers of the first and second layered films are configured so that the window has an average P polarization transmittance and an average S polarization transmittance, calculated over the 50 nm wavelength range of interest between 850 nm and 950 nm, of greater than 85% for light incident on the first surface and the second surface at angles of incidence of less than or equal to 60°.

An aspect (37) of the present disclosure pertains to a window according to the aspect (36), wherein the average P polarization transmittance and the average S polarization transmittance, calculated over the 50 nm wavelength range of interest between 850 nm and 950 nm, are greater than 89% for light incident on the first surface and the second surface at angles of incidence of less than or equal to 60°.

An aspect (38) of the present disclosure pertains to a window according to any of the aspects (34)-(37), wherein the quantity, the thicknesses, number, and materials of the alternating layers of the first and second layered films are configured so that the window has a CIELAB L* value for reflection of less than or equal to 37 for angles of incidence of less than or equal to 60° on the first layered film.

An aspect (39) of the present disclosure pertains to a window according to the aspect (38), wherein the CIELAB L* value for reflection is less than or equal to 25 for angles of incidence of less than or equal to 50° on the first layered film.

An aspect (40) of the present disclosure pertains to a window according to any of the aspects (34)-(39), wherein the quantity, the thicknesses, number, and materials of the alternating layers of the first and second layered films are configured so that the window has CIELAB a* and b* values for reflection of greater than or equal to −6 and less than or equal to 6 when viewed from a side of the first layered film.

An aspect (41) of the present disclosure pertains to a window according to any of the aspects (34)-(40), wherein: one of the alternating layers of the first layered film that is farthest from the substrate forms a terminal surface material of the window, the terminal surface material of the window comprising the lower refractive index material, the first layered firm comprises a scratch resistant layer formed of one of the one or more higher refractive index materials and having a thickness that is greater than or equal to 1500 nm and less than or equal to 5000 nm.

An aspect (42) of the present disclosure pertains to a window according to the aspect (41), wherein: the scratch resistant layer is separated from the terminal surface by a plurality of the alternating layers of the one or more lower index materials and the one or more higher index materials of the first layered film, and the scratch resistant layer is separated from the terminal surface by at least 1000 nm.

An aspect (43) of the present disclosure pertains to a window according to any of the aspects (34)-(42), wherein the second layered film comprises two or more silicon layers having an extinction coefficient of less than or equal to 0.01 over the 50 nm wavelength range of interest.

An aspect (44) of the present disclosure pertains to a window according to the aspect (43), wherein a silicon layer of the second layered film most proximate to the substrate comprises the smallest thickness of the two or more silicon layers.

An aspect (45) of the present disclosure pertains to a window according to the aspect (44), wherein a combined thickness of the silicon layers contained in the second layered film is greater than or equal to 500 nm.

An aspect (46) of the present disclosure pertains to a window according to any of the aspects (43)-(45), wherein a layer of the one or more higher refractive index materials in the second layered film is not silicon.

An aspect (47) of the present disclosure pertains to a window according to the aspect (46), wherein the layer of the one or more higher refractive index materials in the second layered film that is not silicon is the layer of the one or more higher refractive index materials that is most proximate to the substrate.

An aspect (48) of the present disclosure pertains to a window according to any of the aspects (34)-(47), further comprising a perfluoropolyether layer disposed on the first layered film.

An aspect (49) of the present disclosure pertains toa window according to either of the aspect (14) or the aspect (30), wherein the second layered film comprises a layer of TCO material, wherein the two or more silicon layers are disposed between the layer of TCO material and the substrate.

An aspect (50) of the present disclosure pertains to a window according to the aspect (49), wherein the layer of TCO material comprises a sheet resistance that is greater than or equal to 140Ω/□ and less than or equal to 210Ω/□, wherein the layer of TCO material comprises a thickness that is greater than or equal to 20 nm and less than or equal to 30 mm.

An aspect (51) of the present disclosure pertains to a window according to the aspect (50), wherein the layer of TCO material is indium tin oxide and comprises an extinction coefficient that is less than or equal to 0.05 throughout the 50 nm wavelength range of interest.

An aspect (52) of the present disclosure pertains to a window according to any of the preceding aspects, wherein an inner AR stack separates two or more silicon layers from an inner terminal surface of the second layered film, wherein the inner AR stack comprises at least two layers of the one or more higher refractive index materials that are not silicon.

An aspect (53) of the present disclosure pertains to a window according to the aspect (52), wherein the quantity, the thicknesses, number, and materials of the alternating layers of the first and second layered films are configured so that the window has an average percentage reflectance, calculated over the 50 nm wavelength range of interest, of less than 0.5% for light incident on the inner terminal surface at angles of incidence of less than or equal to 15°.

An aspect (54) of the present disclosure pertains to a window according to any of the aspects (51)-(53), wherein the quantity, the thicknesses, number, and materials of the alternating layers of the first and second layered films are configured so that the window has an average percentage transmittance, calculated from 400 nm to 700 nm, of less than 1% for light normally incident on the first surface and the second surface °.

An aspect (55) of the present disclosure pertains to a window according to any of the aspects (51)-(54), wherein: the second layered film comprises at least ten silicon layers, and the inner AR stack comprises less than two layers of the one or more higher refractive index materials that are not silicon.

An aspect (56) of the present disclosure pertains to a window according to the aspect (55), wherein the quantity, the thicknesses, number, and materials of the alternating layers of the first and second layered films are configured so that the window exhibits a polarization averaged reflectance range (max-min) that is less than 0.5% for light that is incident on the first layered film at a 15° angle of incidence, calculated over the wavelength range from 850 nm to 950 nm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a side view of a vehicle in an external environment, illustrating a LIDAR system on a roof of the vehicle and another LIDAR system on a forward portion of the vehicle, according to one or more embodiments of the present disclosure;

FIG. 2 is a schematic view of one of the LIDAR systems of FIG. 1, illustrating an electromagnetic radiation emitter and sensor in an enclosure, the radiation emitter emitting electromagnetic radiation that exits the enclosure through a window and returns as reflected radiation through the window, according to one or more embodiments of the present disclosure;

FIG. 3 is a cross-sectional view of the window of FIG. 2 taken at area III of FIG. 2, illustrating the window including a substrate with a layered film over a first surface of the substrate, and a second layered film over a second surface of the substrate, according to one or more embodiments of the present disclosure;

FIG. 4 is a cross-sectional view of the window of FIG. 3 taken at area IV of FIG. 3, illustrating the layered film including alternating layers of one or more higher refractive index materials and one or more lower refractive index materials with a layer of the one or more lower refractive index materials providing a terminal surface closest to the external environment, according to one or more embodiments of the present disclosure;

FIG. 5 is a cross-sectional view of the window of FIG. 3 taken at area V of FIG. 3, illustrating the second layered film including alternating layers of one or more higher refractive index materials and one or more lower refractive index materials with a layer of the one or more lower refractive index materials providing a terminal surface closest to the electromagnetic radiation emitter and sensor, according to one or more embodiments of the present disclosure;

FIG. 6A is a graph of refractive index and extinction coefficient of silicon materials that may be used in layered films over a wavelength range of 350 nm to 1000 nm, according to one or more embodiments of the present disclosure;

FIG. 6B is a graph of extinction coefficient of the silicon materials represented in FIG. 6A over a wavelength range of 800 nm to 1000 nm, according to one or more embodiments of the present disclosure;

FIG. 7 is a graph of a modeled two-surface transmittance for light in an infrared wavelength range of interest from 850 nm to 950 nm that is incident on the first layered film of a first example window at a 15° angle of incidence, according to one or more embodiments of the present disclosure;

FIG. 8 is a graph of a modeled two-surface transmittance for s and p polarized light in an infrared wavelength range of interest from 850 nm to 950 nm that is incident on the first layered film of the first example window at a 60° angle of incidence, according to one or more embodiments of the present disclosure;

FIG. 9 is a graph of a modelled two-surface reflectance for light in an infrared wavelength range of interest from 850 nm to 950 nm that is incident on the first and second layered films of the first example window at a 15° angle of incidence, according to one or more embodiments of the present disclosure;

FIG. 10 is a graph of a modelled two-surface transmittance for light in the visible spectrum that is incident on the first layered film of the first example window at a 15° angle of incidence, according to one or more embodiments of the present disclosure;

FIG. 11A is a graph of modelled CIELAB color space values a* and b* of reflection for light incident on the first layered film of the first example window at a plurality of angles of incidence, according to one or more embodiments of the present disclosure;

FIG. 11B is a graph of modelled CIELAB lightness value L* of reflection for light incident on the first layered film of the first example window at a plurality of angles of incidence, according to one or more embodiments of the present disclosure;

FIG. 12 is a graph of nanoindentation hardness as a function of depth into first layered films of one sample constructed according to the first example window, according to one or more embodiments of the present disclosure;

FIG. 13 is a graph of a modeled two-surface transmittance for light in a spectral range from 350 nm to 1500 nm that is incident on the first layered film of a second example window, according to one or more embodiments of the present disclosure;

FIG. 14 is a graph of a modeled two-surface reflectance for light in a spectral range from 350 nm to 1500 nm that is incident on the first and second layered films of a second example window, according to one or more embodiments of the present disclosure;

FIG. 15 is a graph of modelled CIELAB color space values a* and b* of reflection for light incident on the first layered film of the second example window at a plurality of angles of incidence, according to one or more embodiments of the present disclosure;

FIG. 16 is a graph of a modeled two-surface transmittance for light in a spectral range from 350 nm to 1500 nm that is incident on the first layered film of a third example window, according to one or more embodiments of the present disclosure;

FIG. 17A is a graph of a modeled two-surface reflectance for light in a spectral range from 350 nm to 1500 nm that is incident on the first and second layered films of a third example window, according to one or more embodiments of the present disclosure;

FIG. 17B is a graph of a modeled two-surface reflectance for light in a spectral range from 850 nm to 950 nm that is incident on the first and second layered films of a third example window, according to one or more embodiments of the present disclosure;

FIG. 18 is a graph of modelled CIELAB color space values a* and b* of reflection for light incident on the first layered film of the third example window at a plurality of angles of incidence, according to one or more embodiments of the present disclosure;

FIG. 19 is a graph of a modeled two-surface transmittance for light in a spectral range from 350 nm to 1600 nm that is incident on the first layered film of a fourth example window, according to one or more embodiments of the present disclosure;

FIG. 20A is a graph of a modeled reflectance for light in a spectral range from 350 nm to 1700 nm that is incident on the first layered film of a fourth example window, according to one or more embodiments of the present disclosure;

FIG. 20B is a graph of a modeled reflectance for light in a spectral range from 350 nm to 1700 nm that is incident on the second layered film of a fourth example window, according to one or more embodiments of the present disclosure;

FIG. 20C is a graph of modeled reflectance for light in the spectral range from 800 nm to 1050 nm that is incident on the first layered films of the third and fourth example windows at a 15° angle of incidence, according to one or more embodiments of the present disclosure;

FIG. 20D is a graph of modeled reflectance for light in the spectral range from 800 nm to 1050 nm that is incident on the first layered films of the third and fourth example windows at a 60° angle of incidence, according to one or more embodiments of the present disclosure;

FIG. 20E is a graph of modeled reflectance for light in the spectral range from 800 nm to 1050 nm that is incident on the second layered films of the third and fourth example windows at a 15° angle of incidence, according to one or more embodiments of the present disclosure; and

FIG. 21 is a graph of modelled CIELAB color space values a* and b* of reflection for light incident on the first layered film of the fourth example window at a plurality of angles of incidence, according to one or more embodiments of the present disclosure.

### DETAILED DESCRIPTION

Reference will now be made in detail to embodiments of windows for use in LIDAR sensors. Whenever possible, the same reference numerals will be used throughout the drawings to refer to the same or like parts. The windows comprise described herein may include first and second layered films that are constructed of alternating layers of higher and lower refractive index materials and configured to provide relatively high transmittance and low reflectance in a desired infrared wavelength range of interest. When the window is installed in a LIDAR system, the first layered film may face away from the sensor/electromagnetic radiation emitter and be exposed to an external environment, while the second layered film may face the sensor/electromagnetic radiation emitter. That is, when the LIDAR system is viewed from the outside, an observer may view the first layered film. Light emitted by the electromagnetic radiation emitter may be initially incident on the second layered film prior to propagating through the substrate. In accordance with the present disclosure, the first layered films of the windows described herein may include one or more scratch resistant layers that are relatively thick (e.g., greater than or equal to 500 nm) of a high refractive index material. The scratch resistant layer may be embedded within the first layered film such that the window comprises a maximum nanoindentation hardness of greater than or equal to 8 GPa (e.g., greater than or equal to 10 GPa, greater than or equal to 12 GPa, greater than or equal to 14 GPa) when measured at the first layered film by the Berkovich Indenter Hardness Test. Such nanoindentation hardness can be at a depth of 1 μm within the first layered film. Such nanoindentation hardness beneficially provides scratch resistance and improves performance of the LIDAR system.

In aspects, the alternating layers of the first and second layered films of the windows described herein are also constructed to provide optical performance attributes that are desirable for operation of the LIDAR system in the infrared spectrum. In embodiments, the quantity, the thicknesses, number, and materials of the alternating layers of the first and second layered films are configured so that the window has an average percentage transmittance, calculated over at least a 50 nm, 60 nm, 70 nm, 80 nm, or 90 nm wavelength range of interest centered about a wavelength in a range from 850 nm to 950 nm, of greater than 90% (e.g., greater than or equal to 95%) for light incident on the first surface and the second surface at angles of incidence of 15° or less. In embodiments, the quantity, the thicknesses, number, and materials of the alternating layers of the first and second layered films are configured so that the window has a transmittance of greater than or equal to 92%, and preferably greater than or equal to 94%, and even more preferably greater than or equal to 96% throughout the spectral range from 950 nm to 950 nm for light at normal incidence. The quantity, the thicknesses, number, and materials of the alternating layers of the first and second layered films may be configured so that the window also comprises an average percentage P-polarization transmittance and S-Polarization transmittance, calculated over the 50 nm (or 60 nm, or 70 nm, or 80 nm, or 90 nm) wavelength range of interest, of greater than 85% (e.g., greater than or equal to 89%, greater than or equal to 90%, greater than or equal to 93%) for light incident on the first surface and the second surface at an angle of incidence of 60 degrees or less. In embodiments, the quantity, the thicknesses, number, and materials of the alternating layers of the first and second layered films are configured so that the window has an average percentage reflectance, calculated over the 50 nm (or 60 nm, or 70 nm, or 80 nm, or 90 nm) wavelength range of interest, of less than or equal to 5.0% (e.g., less than or equal to 4.0%, less than or equal to 3.0%, less than or equal to 2.0%, less than or equal to 1.0%) for light incident on the first surface and the second surface at angles of incidence of 15° or less. In aspects, the quantity, the thicknesses, number, and materials of the alternating layers of the first and second layered films are configured so that the window has an average percentage reflectance (for both S and P-polarizations), off of the second layered film of less than 4.0% (e.g., less than or equal to 3.0%, less than or equal to 2.0%, less than or equal to 1.0) at angles of incidence of less than 15°. In aspects, the quantity, the thicknesses, number, and materials of the alternating layers of the first and second layered films are configured so that the window has an average percentage reflectance (for both S and P-polarizations), off of the second layered film of less than 5.5% (e.g., less than or equal to 5.0%, less than or equal to 4.0%, less than or equal to 3.5%, less than or equal to 3.0%, less than or equal to 2.0%, less than or equal to 1.0) at angles of incidence of less than 45°. In aspects, the quantity, the thicknesses, number, and materials of the alternating layers of the first and second layered films are configured so that the window has an average percentage reflectance (for both S and P-polarizations), off of the second layered film of less than 8.0% (e.g., less than or equal to 7.5%, less than or equal to 7.0%, less than or equal to 6.5%, less than or equal to 6.0%, less than or equal to 5.0%, less than or equal to 5.0%, less than or equal to 4.0%, less than or equal to 3.5%, less than or equal to 3.0%, less than or equal to 2.0%, less than or equal to 1.0) at angles of incidence of less than 60°.

In further aspects, the first and second layered films of the windows described herein may also be structured to have relatively low reflectance and transmittance of visible light, thereby providing the window with an aesthetically pleasing dark appearance and eliminating signal noise. In embodiments, for example, the quantity, the thicknesses, number, and materials of the alternating layers of the first and second layered films are configured so that the window has an average percentage transmission, calculated from 400 nm to 700 nm of less than 5% (e.g., less than or equal to 4.5%, less than or equal to 4.0%, less than or equal to 3.5%, less than or equal to 3.0%, less than or equal to 2.5%, less than or equal to 2.0%) for light incident on the first layered film at angles of incidence of 15° or less. In embodiments, for example, the quantity, the thicknesses, number, and materials of the alternating layers of the first and second layered films are configured so that the window has an average percentage transmission, calculated from 450 nm to 650 mm nm of less than 1% for light normally incident on the first layered film. Such low transmission of visible light may be achieved by incorporating absorber layers into the second layered film in the amounts described herein.

The windows can also exhibit low reflection in the visible wavelength range. In embodiments, for example, the quantity, the thicknesses, number, and materials of the alternating layers of the first and second layered films are configured so that the window has an average percentage reflectance, calculated from 450 nm to 650 nm of less than 10% (e.g., less than or equal to 9.0%, less than or equal to 8.0%, less than or equal to 7.0%, less than or equal to 6.0%, less than or equal to 5.0%, less than or equal to 4.5%, less than or equal to 4.0%, less than or equal to 3.5%, less than or equal to 3.0%, less than or equal to 2.5%, less than or equal to 2.0%) for light incident on the first layered film at angles of incidence of 15° or less ∘. In embodiments, the quantity, the thicknesses, number, and materials of the alternating layers of the first and second layered films are configured so that the window has an average percentage reflectance, calculated from 450 nm to 650 nm of less than 12% (e.g., less than or equal to 11%, less than or equal to 10%, less than or equal to 9.0%, less than or equal to 8.0%, less than or equal to 7.0%, less than or equal to 6.0%, less than or equal to 5.0%, less than or equal to 4.5%, less than or equal to 4.0%, less than or equal to 3.5%, less than or equal to 3.0%, less than or equal to 2.5%, less than or equal to 2.0%) for light incident on the first layered film at angles of incidence of 45° or less ∘. In embodiments, the quantity, the thicknesses, number, and materials of the alternating layers of the first and second layered films are configured so that the window has an average percentage reflectance, calculated from 450 nm to 650 nm of less than 16% (e.g., less than or equal to 15%, less than or equal to 14%, less than or equal to 13%, less than or equal to 12%, less than or equal to 11%, less than or equal to 10%, less than or equal to 9.0%, less than or equal to 8.0%, less than or equal to 7.0%, less than or equal to 6.0%, less than or equal to 5.0%, less than or equal to 4.5%, less than or equal to 4.0%, less than or equal to 3.5%, less than or equal to 3.0%, less than or equal to 2.5%, less than or equal to 2.0%) for light incident on the first layered film at angles of incidence of 60° or less ∘.

When viewed from the first layered film (i.e., from outside the LIDAR sensor), the windows described herein may exhibit reflection with CIELAB lightness L* values of less than or equal to 40 (e.g., less than or equal to 37, less than or equal to 35, less than or equal to 30) when viewed from angles of 60 degrees or less. The windows described herein may also exhibit reflection with CIELAB color space a* and b* values that are greater than or equal to −6 and less than or equal to 6 (e.g., greater than or equal to −5 and less than or equal to 5, greater than or equal to −4 and less than or equal to 4, greater than or equal to −3 and less than or equal to 3, greater than or equal to −2.5 and less than or equal to 2.5) when viewed from the first layered film when illuminated by an illuminant source at a plurality of different angles of incidence, ranging from 0° to 90°. The perceived color of the window, when viewed from the side of the first layered film, may be black or relatively dark so as to render the window less noticeable to outside observers. In embodiments, the windows exhibit CIELAB color space a* and b* values that are greater than or equal to 2.5 and less than or equal to 2.5 when illuminated by an illuminant source at a plurality of different angles of incidence, ranging from 0° to 60.°

In further aspects, the windows described herein may be characterized in that they exhibit a relatively high transmittance (e.g., greater than or equal to 90%) over a 50 nm (or 60 nm, or 70 nm, or 80 nm, or 90 nm) wavelength range of interest that is centered at a wavelength from 850 nm to 950 nm, while simultaneously exhibiting a relatively low average transmittance (e.g., less than or equal to 5%) in the visible spectrum (from 400 nm to 700 nm). Such contrasts in transmission at relatively close spectral ranges is achieved via incorporating absorber layers having relatively low extinction coefficients within the 50 nm (or 60 nm, or 70 nm, or 80 nm, or 90 nm) wavelength range of interest. In embodiments, the absorber layers should have an extinction coefficient of less than or equal to 0.01 (e.g., less than or equal to 0.009, less than or equal to 0.008, less than or equal to 0.007, less than or equal to 0.005, less than or equal to 0.004, less than or equal to 0.0035, less than or equal to 0.0030, less than or equal to 0.0025, less than or equal to 0.0020, less than or equal to 0.0015, less than or equal to 0.0010) at a wavelength within a 50 nm (or 60 nm, or 70 nm, or 80 nm, or 90 nm) wavelength range of interest between 850 nm and 950 nm. In embodiments, the absorber layers may simultaneously exhibit extinction coefficients in the visible spectrum that are relatively high (e.g., greater than or equal to 0.05, greater than or equal to 0.06, greater than or equal to 0.07, greater than or equal to 0.08) to absorb sufficient visible light to facilitate providing the dark, opaque appearance described herein. An example material for an absorber layer described herein is a silicon material having a low extinction coefficient over the 50 nm (or 60 nm, or 70 nm, or 80 nm, or 90 nm) wavelength range of interest. When incorporated into the first and second layered films in the amounts described herein, such layers can absorb sufficient visible light to provide a suitable dark appearance, while also achieving the relatively high transmission within the 50 nm (or 60 nm, or 70 nm, or 80 nm, or 90 nm) wavelength range of interest in the near infrared.

As such, the windows described herein provide durable anti-reflection performance for a desired wavelength range of interest from 850 nm to 950 nm, while providing an aesthetically pleasing and performance enhancing black or dark appearance. The windows described herein may improve LIDAR sensor performance over certain existing sensors by preventing visible light from being incident on the sensors and improving signal-to-noise ratio. Moreover, the windows described herein may reduce unwanted glare that is visible to outside observers.

Unless otherwise noted, the total, specular, and average reflectance values provided herein are two-surface reflectance values, representing a total reflectance of an entire window, including the reflectance associated with each material interface in the window (e.g., between air and the layered films, between the layered films and the substrate, etc.). Unless otherwise noted, reflectance values provided in the infrared are measured from the side of the second layered film described herein (e.g., from the side positioned facing a sensor and emitter of a LIDAR system) and reflectance values provided in the visible are measured from the side of the first layered film described herein (e.g., from the side positioned facing an external environment of a LIDAR system).

Unless otherwise specified herein, average transmittance and reflectance values are calculated using percentage reflectance and transmittance values at various wavelengths within a specified wavelength range. Average reflectance transmittance values may be calculated by averaging values at each whole number wavelength within the specified wavelength range.

Unless otherwise noted herein, CIELAB color space a* and b* and lightness L* values are measured/simulated using a D65 illuminate for a standard observer with a 10-degree field of view.

As used herein, the terms “dark appearance” or “black appearance” refer to the reflected appearance of the window when viewed from an external surface. Windows having a dark appearance or black appearance in accordance with the present disclosure comprise average transmittance of 5% or less within 400-700 nm when viewed from 60° or less and reflection with CIELAB lightness L* values of less than 45 when viewed from angles 60° or less.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “Comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “formed from” can mean one or more of comprises, consists essentially of, or consists of. For example, a component that is formed from a particular material can comprise the particular material, consist essentially of the particular material, or consist of the particular material.

As also used herein, the terms “article,” “glass-article,” “ceramic-article,” “glass-ceramics,” “glass elements,” “glass-ceramic article” and “glass-ceramic articles” may be used interchangeably, and in their broadest sense, to include any object made wholly or partly of glass and/or glass-ceramic material.

The term “disposed” is used herein to refer to a layer or sub-layer that is coated, deposited, formed, or otherwise provided onto a surface. The term disposed can include layers/sub-layers provided in direct contact with adjacent layers/sub-layers or layers/sub-layers separated by intervening material which may or may not form a layer.

Unless otherwise noted herein, refractive indices of the materials described herein are measured at 905 nm.

As used herein, the term “extinction coefficient” or “k” is a dimensionless property of a material that is dependent on a material's absorption coefficient, times a wavelength of light divided by 4π.

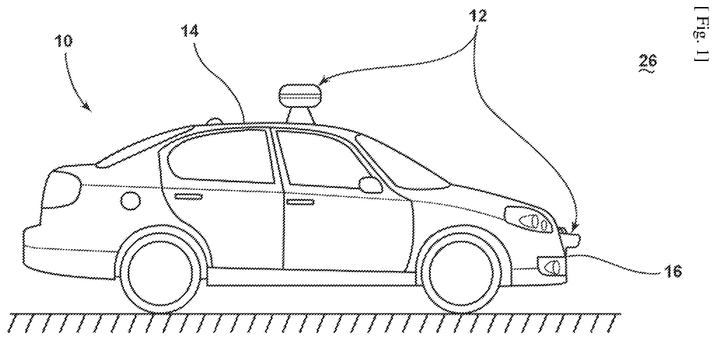

Referring now to FIG. 1, a vehicle 10 includes one or more LIDAR systems 12. The one or more LIDAR systems 12 can be disposed anywhere on or within the vehicle 10. For example, the one or more LIDAR systems 12 can be disposed on a roof 14 of the vehicle 10 and/or a forward portion 16 of the vehicle 10.

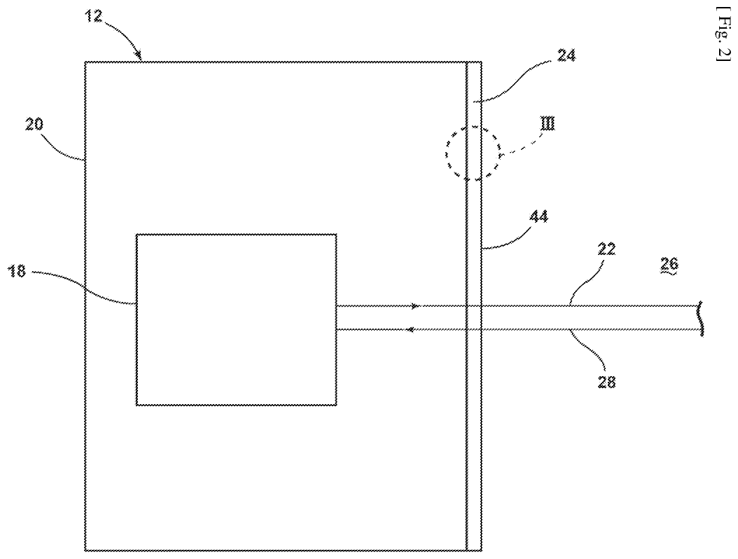

Referring now to FIG. 2, each of the one or more LIDAR systems 12 include an electromagnetic radiation emitter and sensor 18, as known in the art, which may be enclosed in an enclosure 20. The electromagnetic radiation emitter and sensor 18 emits electromagnetic radiation 22 having a wavelength or range of wavelengths.

The emitted radiation 22 exits the enclosure 20 through a window 24, which is in the path of the emitted electromagnetic radiation. If an object (not illustrated) in an external environment 26 is in the path of the emitted radiation 22, the emitted radiation 22 will reflect off of the object and return to the electromagnetic radiation emitter and sensor 18 as reflected radiation 28. The reflected radiation 28 again passes through the window 24 to reach the electromagnetic radiation emitter and sensor 18. In embodiments, the emitted radiation 22 and the reflected radiation 28 may include light within a suitable wavelength range of interest. For example, in embodiments, the emitted radiation 22 and reflected radiation 28 may be greater than or equal to 850 nm and less than or equal to 950 nm (e.g., greater than or equal to 875 nm and less than or equal to 925 nm, greater than or equal to 890 nm and less than or equal to 910 nm, approximately 905 nm, 905 nm). Electromagnetic radiation other than the reflected radiation 28 (such as electromagnetic radiation having wavelengths in the visible spectrum, portions of the ultraviolet range) may also interact with the window 24. As described herein, the window 24 may include layered films comprising layer structures that are designed to absorb light in the visible spectrum while also reflecting relatively low amounts of light in the visible spectrum, such that the window has a dark or black appearance when viewed from outside of the enclosure 20.

The “visible spectrum” is the portion of the electromagnetic spectrum that is visible to the human eye and generally refers to electromagnetic radiation having a wavelength within the range of about 400 nm to about 700 nm. The “ultraviolet range” is the portion of the electromagnetic spectrum having wavelengths between about 10 nm and about 400 nm. The “infrared range” of the electromagnetic spectrum begins at about 700 nm and extends to longer wavelengths. The sun generates solar electromagnetic radiation, commonly referred to as “sunlight,” having wavelengths that fall within all three of those ranges.

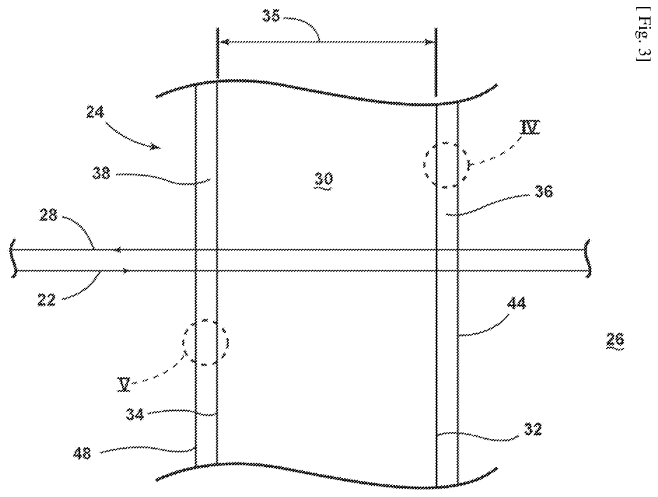

Referring now to FIG. 3, the window 24 for each of the one or more LIDAR systems 12 includes a substrate 30. The substrate 30 includes a first surface 32 and a second surface 34. The first surface 32 and the second surface 34 are the primary surfaces of the substrate 30. The first surface 32 is closest to the external environment 26. The second surface 34 is closest to the electromagnetic radiation emitter and sensor 18. The emitted radiation 22 encounters the second surface 34 before the first surface 32. The reflected radiation 28 encounters the first surface 32 before the second surface 34. The substrate 30 further includes a first layered film 36 disposed on the first surface 32 of the substrate 30 and a second layered film 38 is disposed on the second surface 34 of the substrate 30. It should be understood that the window 24 as described herein is not limited to vehicular applications, and can be used for whatever application the window 24 would be useful to provide improved impact and optical performance, as described further herein.

The substrate 30 may be constructed from a variety of different materials in accordance with the present disclosure. In embodiments, the substrate 30 may be constructed of any type of glass, a glass ceramic, ceramic, or a suitable polymer-based material. Various example structures and compositions of the substrate 30 are now described in greater detail.

In embodiments, the substrate 30 includes a glass composition or is a glass article. The substrate 30, for example, can include a borosilicate glass, an aluminosilicate glass, soda-lime glass, chemically strengthened borosilicate glass, chemically strengthened aluminosilicate glass, or chemically strengthened soda-lime glass. In embodiments, the glass composition of the substrate 30 is capable of being chemically strengthened by an ion-exchange process. In embodiments, the composition may be free of lithium ions.

An alkali aluminosilicate glass composition suitable for the substrate 30 comprises alumina, at least one alkali metal and, In embodiments, greater than 50 mol. % SiO₂, in other embodiments at least 58 mol. % SiO₂, and in still other embodiments at least 60 mol. % SiO₂, wherein the ratio (Al₂O₃+B₂O₃)/Σ_{modifiers} (i.e., sum of modifiers) is greater than 1, wherein the ratio of the components are expressed in mol. % and the modifiers are alkali metal oxides. This composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio (Al₂O₃+B₂O₃)/Σ_{modifiers} (i.e., sum of modifiers) is greater than 1.

Another suitable alkali aluminosilicate glass composition for the substrate 30 comprises: 64-68 mol. % SiO₂; 12-16 mol. % Na₂O; 8-12 mol. % Al₂O₃; 0-3 mol. % B₂O₃; 2-5 mol. % K₂O₃ 4-6 mol. % MgO; and 0-5 mol. % CaO, wherein: 66 mol. %≤SiO₂+B₂O₃+CaO≤69 mol. %; Na₂O+K₂O+B₂O+MgO+CaO+SrO>10 mol. %; 5 mol. %≤MgO+CaO+SrO≤8 mol. %; (Na₂O+B₂O₃)—Al₂O₃≤2 mol. %; 2 mol. %≤Na₂O—Al₂O₃≤6 mol. %; and 4 mol. %≤(Na₂O+K₂O)—Al₂O₃≤10 mol. %.

Another suitable alkali aluminosilicate glass composition for the substrate 30 comprises: 2 mol. % or more of Al₂O₃ and/or ZrO₂, or 4 mol. % or more of Al₂O₃ and/or ZrO₂.

One example glass composition comprises SiO₂, B₂O₃, and Na₂O, where (SiO₂+B₂O₃)≥66 mol. %, and Na₂O≥9 mol. %. In an embodiment, the composition includes at least 6 wt. % aluminum oxide. In a further embodiment, the composition of one or more alkaline earth oxides, such as a content of alkaline earth oxides, is at least 5 wt. %. Suitable compositions, In embodiments, further comprise at least one of K₂O, MgO, and CaO. In a particular embodiment, the composition of the substrate 30 comprises 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example composition suitable for the substrate 30 comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further example glass composition suitable for the substrate 30 comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

The substrate 30 may be substantially planar or sheet-like, although other embodiments may utilize a curved or otherwise shaped or sculpted substrate. The length and width of the substrate 30 can vary according to the dimensions required for the window 24. The substrate 30 can be formed using various methods, such as float glass processes and down-draw processes such as fusion draw and slot draw. The substrate 30 can be used in a non-strengthened state. A commercially available example of a suitable non-strengthened substrate 30 for the window 24 is Corning & glass code 2320, which is a sodium aluminosilicate glass substrate.

The glass forming the substrate 30 can be modified to have a region contiguous with the first surface 32 and/or a region contiguous with the second surface 34 to be under compressive stress (“CS”). In such a circumstance, the region(s) under compressive stress extends from the first surface 32 and/or the second surface 34 to a depth(s) of compression. This generation of compressive stress further creates a central region that is under a tensile stress, having a maximum value at the center of the central region, referred to as central tension or center tension (CT). The central region extends between the depths of compression, and is under tensile stress. The tensile stress of the central region balances or counteracts the compressive stresses of the regions under compressive stress. As used herein, the terms “depth of compression” and “DOC” refer to the depth at which the stress within the substrate 30 changes from compressive to tensile stress. At the depth of compression, the stress crosses from a positive (compressive) stress to a negative (tensile) stress and thus has a value of zero. The depth of compression protects the substrate 30 from the propagation of flaws introduced by sharp impact to the first and/or second surfaces 32, 34 of the substrate 30, while the compressive stress minimizes the likelihood of a flaw growing and penetrating through the depths of compression. In embodiments, the depths of compression are each at least 20 μm. In embodiments, the absolute value of the maximum compressive stress CS within the regions is at least 200 MPa, at least about 400 MPa, at least 600 MPa, or up to about 1000 MPa.

Two methods for extracting detailed and precise stress profiles (stress as a function of depth) for a substrate 30 with regions under compressive stress are disclosed in U.S. Pat. No. 9,140,543, entitled “Systems and Methods for Measuring the Stress Profile of Ion-Exchanged Glass,” filed by Douglas Clippinger Allan et al. on May 3, 2012, and claiming priority to U.S. Provisional Patent Application No. 61/489,800, having the same title, and filed on May 25, 2011, the contents of which are incorporated herein by reference in their entirety.

In embodiments, generating the region(s) of the substrate 30 under compressive stress includes subjecting the substrate 30 to an ion-exchange chemical tempering process (chemical tempering is often referred to as “chemical strengthening”). In the ion-exchange chemical tempering process, ions at or near the first and second surfaces 32, 34 of the substrate 30 are replaced by—or exchanged with—larger ions usually having the same valence or oxidation state. In those embodiments in which the substrate 30 comprises, consists essentially of, or consists of an alkali aluminosilicate glass, an alkali borosilicate glass, an alkali aluminoborosilicate glass, or an alkali silicate glass, ions in the surface layer of the glass and the larger ions are monovalent alkali metal cations, such as Na⁺ (when Li⁺ is present in the glass), K⁺, Rb⁺, and Cs⁺. Alternatively, monovalent cations in, at, or near the first and second surfaces 32, 34 may be replaced with monovalent cations other than alkali metal cations, such as Ag⁺ or the like.

In embodiments, the ion-exchange process is carried out by immersing the substrate 30 in a molten salt bath containing the larger ions to be exchanged with the smaller ions in the substrate 30. It will be appreciated by those skilled in the art that parameters for the ion-exchange process, including, but not limited to, bath composition and temperature, immersion time, the number of immersions of the glass in a salt bath (or baths), use of multiple salt baths, and additional steps such as annealing, washing and the like, are generally determined by the composition of the substrate 30 and the desired depths of compression and compressive stress of the substrate 30 that result from the strengthening operation. By way of example, ion-exchange of alkali metal-containing glass substrates may be achieved by immersion in at least one molten bath containing a salt such as, but not limited to, nitrates, sulfates, and chlorides of the larger alkali metal ion. In embodiments, the molten salt bath comprises potassium nitrate (0-100 wt %), sodium nitrate (0-100 wt %), and lithium nitrate (0-12 wt %), the combined potassium nitrate and sodium nitrate having a weight percentage within the range of 88 wt % to 100 wt %. In embodiments, the temperature of the molten salt bath typically is in a range from about 350° C. up to about 500° C., while immersion times range from about 15 minutes up to about 40 hours, including from about 20 minutes to about 10 hours. However, temperatures and immersion times different from those described above may also be used. The substrate 30 may be acid polished or otherwise treated to remove or reduce the effect of surface flaws.

In embodiments, the substrate 30 includes a glass-ceramic material having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite. “Glass-ceramics” include materials produced through controlled crystallization of glass. Examples of suitable glass-ceramics may include Li2O—Al2O3—SiO2 system (i.e., LAS-System) glass-ceramics, MgO—Al2O3-SiO2 system (i.e., MAS-System) glass-ceramics, ZnO×Al2O3×nSiO2 (i.e., ZAS system), and/or glass-ceramics that include a predominant crystal phase including β-quartz solid solution, β-spodumene, cordierite, and lithium disilicate. The glass-ceramic substrates may be strengthened using a chemical strengthening process.

In embodiments, the substrate 30 includes a ceramic material such as inorganic crystalline oxides, nitrides, carbides, oxy nitrides, carbo nitrides, and/or the like. Illustrative ceramics include those materials having an alumina, aluminum titanate, mullite, cordierite, zircon, spinel, perovskite, zirconia, ceria, silicon carbide, silicon nitride, silicon aluminum oxynitride, or zeolite phase.

In embodiments, the substrate 30 includes an organic or suitable polymeric material. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins.

In embodiments, the substrate 30 includes a plurality of layers or sub-layers. The layers or sub-layers of the substrate 30 may be the same or different from one another. In embodiments, for example, the substrate 30 comprises a glass laminate structure. In embodiments, the glass laminate structure comprises a first glass pane and a second pane attached to one another via a suitable interlayer (e.g., a polymer interlayer) disposed between the first glass pane and the second glass pane. In embodiments, the glass laminate structure comprises a glass-on-glass laminate structure formed via, for example, the fusion draw process. Glass-polymer laminates are also contemplated and within the scope of the present disclosure. Any material capable of meeting the optical requirements described herein may be used as the substrate 30.

In embodiments, the substrate 30 exhibits an elastic modulus (or Young's modulus) in the range from about 30 GPa to about 120 GPa. In some instances, the clastic modulus of the substrate may be in the range from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, from about 70 GPa to about 120 GPa, and all ranges and sub-ranges therebetween.

In embodiments, the substrate 30 exhibits an average transmittance over the visible wavelength regime of about 85% or greater, about 86% or greater, about 87% or greater, about 88% or greater, about 89% or greater, about 90% or greater, about 91% or greater or about 92% or greater. In embodiments, the substrate 30 comprises a tinting component (e.g., tinting layer or additive) and may optionally exhibit a color, such as white, black, red, blue, green, yellow, orange etc.

As depicted in FIG. 3, the substrate 30 has a thickness 35 defined as the shortest straight-line distance between the first surface 32 and the second surface 34. In embodiments, the thickness 35 of the substrate 30 is between about 100 μm and about 5 mm. In embodiments, the substrate 30 can have a physical thickness 35 ranging from about 100 μm to about 500 μm (e.g., 100, 200, 300, 400, or 500 μm). In other embodiments, the thickness 35 ranges from about 500 μm to about 1000 μm (e.g., 500, 600, 700, 800, 900, or 1000 μm). The thickness 35 may be greater than about 1 mm (e.g., about 2, 3, 4, 5 mm, 6 mm, or 7 mm). In one or more specific embodiments, the thickness 35 is 2 mm or less or less than or equal to 1 mm.

In embodiments, the thickness 35 is uniform (e.g., varies by less than 1% throughout an entirety of the substrate) such that the substrate 35 is in the form of a planar sheet. In embodiments, the thickness 35 is a variable thickness and has a value that varies as a function of position on the substrate 30. The thickness 35 may vary along one or more of its dimensions for aesthetic and/or functional reasons. For example, the edges of the substrate 30 may be thicker as compared to more central regions of the substrate 30. The length, width and physical thickness dimensions of the substrate 30 may also vary according to the application or use of the article 30.

In embodiments, the substrate 30 includes a visible light absorbing, IR-transmitting material layer. Examples of such materials include infrared transmitting, visible absorbing acrylic sheets, such as those commercially available from ePlastics under the trade names Plexiglas BIR acrylic 3143 and CYRO's ACRYLITE® IR acrylic 1146. Plexiglas® IR acrylic 3143 has a transmissivity of about 0% (at least less than 10%, or less than 1%) for electromagnetic radiation having wavelengths of about 700 nm or shorter, but a transmissivity of about 90% (above 85%) for wavelengths within the range of 800 nm to about 1100 nm (including 905 nm).

In embodiments, the substrate 30 exhibits a refractive index in the range from about 1.45 to about 1.55. In embodiments, the substrate exhibits an average transmission of greater than or equal to 95% (e.g., greater than or equal to 96%, greater than or equal to 97%, greater than or equal to 98%, greater than or equal to 99%, greater than or equal to 99.5%) throughout a spectral range from 1400 nm to 1600 nm.

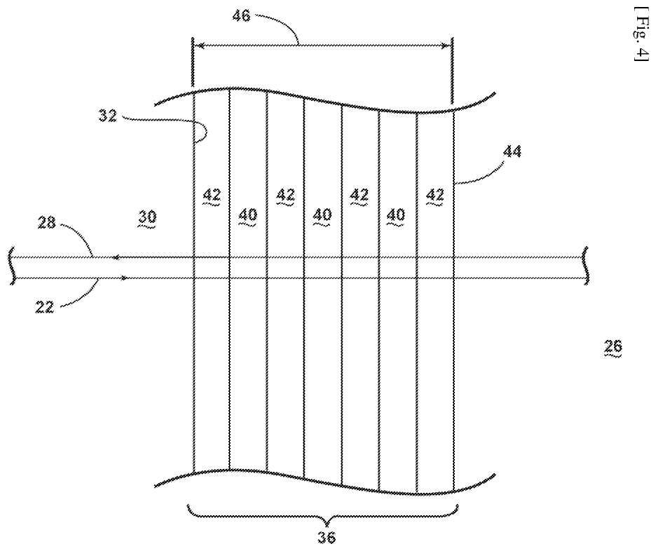

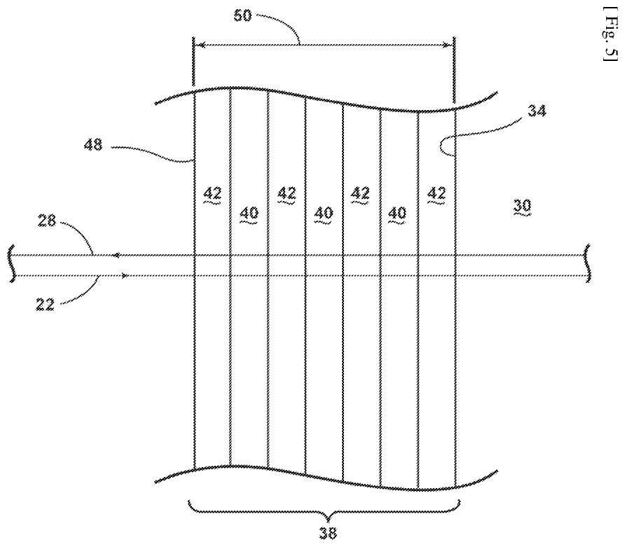

Referring now to FIGS. 4 and 5, the first layered film 36 and the second layered film 38 each include a quantity of alternating layers of one or more higher refractive index materials 40 and one or more lower refractive index materials 42. While each of the one or more higher refractive index materials 40 and the one or more lower index materials 42 are identified using the same reference numerals, it should be understood that the utilization of the same reference numeral does not indicate that each of the layers are constructed of the same material or include the same structure. In each of the first and second layered films 36 and 38, different ones of the layers of the respective higher refractive index materials 40 and the lower refractive index materials 42 may include different compositional or structural properties.

As used herein, the terms “higher refractive index” and “lower refractive index” refer to the values of the refractive index relative to each other, with the refractive index/indices of the one or more higher refractive index materials 40 being greater than the refractive index/indices of the one or more lower refractive index materials 42. In embodiments, the one or more higher refractive index materials 40 have a refractive index from about 1.7 to about 4.5. In embodiments, the one or more lower refractive index materials 42 have a refractive index from about 1.3 to about 1.6. In embodiments, the one or more lower refractive index materials 42 have a refractive index from about 1.3 to about 1.7, while the one or more higher refractive index materials 40 have a refractive index from about 1.9 to about 3.8. The difference in the refractive index of any of the one or more higher refractive index materials 40 and any of the one or more lower refractive index materials 42 may be about 0.1 or greater, 0.2 or greater, 0.3 or greater, 0.4 or greater, 0.5 or greater, 0.6 or greater, 0.7 or greater, 0.8 or greater, 0.9 or greater, 1.0 or greater, 1.5 or greater, 2.0 or greater, 2.1 or greater, 2.2 or greater, or even 2.3 or greater. Because of the difference in the refractive indices of the one or more higher refractive index materials 40 and the one or more lower refractive index materials 42, manipulation of the quantity (number) of alternating layers and their thicknesses can cause selective transmission of electromagnetic radiation within a range of wavelengths through the window 24 and, separately, selective reflectance of electromagnetic radiation within a range of wavelengths off of the first layered film 36. The first layered film 36 (and the second layered film 38, if utilized) is thus a thin-film optical filter having predetermined optical properties configured as a function of the quantity, thicknesses, number, and materials chosen as the one or more higher refractive index materials 40 and the one or more lower refractive index materials 42.

Some examples of suitable materials for use as the one or more lower refractive index materials 42 include SiO₂, Al₂O₃, GeO₂, SiO, AlOₓN_{y}, SiOₓN_{y}, SiᵤAlᵥOₓN_{y}, MgO, MgAl₂O₄, MgF₂, BaF₂, CaF₂, DyF₃, YbF₃, YF₃, and CeF₃. The nitrogen content of the materials for use as the one or more lower refractive index materials 42 may be minimized (e.g., in materials such as AlOₓN_{y}, SiOₓN_{y}, and SiᵤAlᵥOₓN_{y}).

Some examples of suitable materials for use as the one or more higher refractive index materials 40 include Si, amorphous silicon (a-Si), SiNₓ, SiNₓ:H_{y}, AlNₓ, SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, MoO₃, and diamond-like carbon. The oxygen content of the materials for the higher refractive index material 40 may be minimized, especially in SiNₓ or AlNₓ materials. AlOₓN_{y} materials may be considered to be oxygen-doped AlNₓ, that is they may have an AlNₓ crystal structure (e.g., wurtzite) and need not have an AlON crystal structure. Exemplary preferred AlOₓN_{y} materials for use as the one or more higher refractive index materials 40 may comprise from about 0 atom % to about 20 atom % oxygen, or from about 5 atom % to about 15 atom % oxygen, while including 30 atom % to about 50 atom % nitrogen. Exemplary preferred SiᵤAlᵥOₓN_{y} for use as the one or more higher refractive index materials 40 may comprise from about 10 atom % to about 30 atom % or from about 15 atom % to about 25 atom % silicon, from about 20 atom % to about 40 atom % or from about 25 atom % to about 35 atom % aluminum, from about 0 atom % to about 20 atom % or from about 1 atom % to about 20 atom % oxygen, and from about 30 atom % to about 50 atom % nitrogen. The foregoing materials may be hydrogenated up to about 30% by weight. Because the refractive indices of the one or more higher refractive index materials 40 and the one or more lower refractive index materials 42 are relative to each other, the same material (such as Al₂O₃) can be appropriate for the one or more higher refractive index materials 40 depending on the refractive index of the material(s) chosen for the one or more lower refractive index materials 42, and can alternatively be appropriate for the one or more lower refractive index materials 42 depending on the refractive index of the material(s) chosen for the one or more higher refractive index material 40.

In embodiments, the one or more lower refractive index materials 42 of the first layered film 36 consists of layers of SiO₂, and the one or more higher refractive index materials 40 of the first layered film 36 consists of layers of SiOₓN_{y} or SiNₓ. In embodiments, the one or more lower refractive index materials 42 of the first layered film 36 consists of layers of SiO₂, and the one or more higher refractive index materials 40 of the first layered film 36 consists of layers of SiNₓ or SiOₓN_{y}, while the one or more lower refractive index materials 42 of the second layered film 38 consists of layers of SiO₂ and the one or more higher refractive index materials 40 of the second layered film 38 comprises layers of silicon (e.g., a-Si). In embodiments, the one or more lower refractive index materials 42 of the first layered film 36 consists of layers of SiO₂, and the one or more higher refractive index materials 40 of the first layered film 36 consists of layers of SiNₓ or SiOₓN_{y}, while the one or more lower refractive index materials 42 of the second layered film 38 consists of layers of SiO₂ and the one or more higher refractive index materials 40 of the second layered film 38 comprises layers of amorphous silicon (a-Si) and layers of SiNₓ or SiOₓN_{y}.

The quantity of alternating layers of the higher refractive index material 40 and the lower refractive index material 42 in either the first layered film 36 or the second layered film 38 is not particularly limited. In embodiments, the number of alternating layers within the first layered film 36 is 7 or more, 9 or more, 11 or more, 13 or more, 15 or more, 17 or more, 19 or more, 21 or more, 23 or more, 25 or more, or 51 or more, or 81 or more. In embodiments, the quantity of alternating layers within the second layered film 38 is 7 or more, 9 or more, 11 or more, 13 or more, 15 or more, 17 or more, 19 or more, 21 or more, 23 or more, or 25 or more, or 51 or more, or 81 or more. In embodiments, the quantity of alternating layers in the first layered film 36 and the second layered film 38 collectively forming the window 24, not including the substrate 30, is 14 or more, 20 or more, 26 or more, 32 or more, 38 or more, 44 or more, 50 or more, 72 or more, or 100 or more. In general, the greater the quantity of layers within the first layered film 36 and the second layered film 38, the more narrowly the transmittance and reflectance properties of the window 24 are tailored to one or more specific wavelengths or wavelength ranges.

Each of the alternating layers of the first layered film 36 and the second layered film 38 has a thickness. The thicknesses selected for each of the alternating layers determines the optical path lengths of light propagating through the window 24 and determines the constructive and destructive interference between different light rays reflected at each material interface of the window 24. Accordingly, the thicknesses of each of the alternating layers, in combination with the refractive index of the one or more higher refractive index materials 40 and the one or more lower refractive index materials 42 determines the reflectance and transmittance spectra of the window 24.

With reference to FIGS. 3, 4, and 5, the reflected radiation 28 first encounters a terminal surface 44 of the first layered film 36 upon interacting with the window 24, and the terminal surface 44 may be open to the external environment 26. In an embodiment, a layer of the one or more lower refractive index materials 42 provides the terminal surface 44 to more closely match the refractive index of the air in the external environment 26 and thus reduce reflection of incident electromagnetic radiation (whether the reflected radiation 28 or otherwise) off of the terminal surface 44. The layer of the one or more lower refractive index materials 42 that provides the terminal surface 44 is the layer of the first layered film 36 that is farthest from the substrate 30. Similarly, in embodiments, when the one or more lower refractive index materials 42 is SiO₂, a layer of SiO₂, as the one or more lower refractive index materials 42, is disposed directly onto the first surface 32 of the substrate 30, which will typically comprise a large mole percentage of SiO₂. Without being bound by theory, it is thought that commonality of SiO₂ in both the substrate 30 and the adjacent layer of the one or more lower refractive index materials 42 allows for increased bonding strength.

The emitted radiation 22 first encounters a terminal surface 48 of the second layered film 38 upon interacting with the window 24. In an embodiment, a layer of the one or more lower refractive materials 42 provides the terminal surface 48 to more closely match the refractive index of the air within the enclosure 20 and thus reduce reflection of the incident emitted radiation 22 off of the terminal surface 48. The layer of the one or more lower refractive index materials 42 that provides the terminal surface 48 is the layer of the second layered film 38 that is farthest from the substrate 30. Similarly, in embodiments, when the one or more lower refractive index materials 42 is SiO₂, a layer of SiO₂, as the one or more lower refractive index materials 42, is disposed directly onto the second surface 34 of the substrate 30.

Materials that have a relatively high refractive index can simultaneously have a relatively high hardness that provides scratch and impact resistance. An example material that has both high hardness and can be one of the one or more higher refractive index material 40 is SiOₓN_{y}. Other example materials that have both high hardness and can be the higher refractive index material 40 are SiNₓ, SiNₓ:H_{y}, and Si₃N₄. It has been found that a relatively thick (e.g., greater than or equal to 500 nm) layer of SiOₓN_{y} (or other suitable higher refractive index material) may increase the scratch and/or damage resistance of the window 24. Such increased scratch and/or damage resistance may be particularly beneficial in the first layered film 36, which may be more likely to encounter impacts of debris from the external environment 26. Accordingly, in embodiments, the first layered film 36 comprises a layer of one of the one or more higher refractive index materials 40 with a thickness greater than or equal to 500 nm (e.g., greater than or equal to 1000 nm, greater than or equal to 1500 nm, greater than or equal to 2000 nm). Such a higher refractive index layer having such a thickness of 500 nm or more is described herein as a “scratch resistant layer.”

In embodiments, the thickness and location within the first layered film 36 of the scratch resistant layer can be optimized to provide a desired level of hardness and scratch resistance to the first layered film 36 and thus the window 24 as a whole. Different applications of the window 24 could lead to different desired thicknesses for the scratch resistant layer of the higher refractive index material 40 serving as the layer providing the hardness and scratch resistance to the window 24. For example, a window 24 protecting a LIDAR system 12 on a vehicle 10 may require a different thickness for the scratch resistant layer of the higher refractive index material 40 than a window 24 protecting a LIDAR system 12 at an office building. In embodiments, the scratch resistant layer of the higher refractive index material 40 serving as the layer providing the hardness and scratch resistance to the window 24 has a thickness between 500 nm and 50000 nm, such as between 500 nm and 10000 nm, such as between 2000 nm to 5000 nm. In embodiments, the thickness of this scratch resistant layer of higher refractive index material 40 has a thickness that is 30% or more, 40% or more, 50% or more, 65% or more, or 85% or more, or 86% or more, of the thickness of the first layered film 36. In general, the scratch resistant layer of the higher refractive index material 40 serving as the layer providing the hardness and scratch resistance to the window 24 will be part of the first layered film 36 facing the external environment 26 rather the second layered film 38 protected by the enclosure 20, although that may not always be so.

As will be detailed further below, the quantity, thicknesses, number, and materials of the remaining layers of the first layered film 36 and the second layered film 38 can be configured to provide the window 24 with the desired optical properties (transmittance and reflectance of desired wavelengths) almost regardless of the thickness chosen for the scratch resistant layer of the higher refractive index material 40 serving as the layer providing the hardness and scratch resistance to the window 24. This insensitivity of the optical properties of the window 24 as a whole to the thickness of the scratch resistant layer of the higher refractive index material 40 serving as the layer providing the hardness and scratch resistance to the window 24 when materials having relatively low or negligible optical absorption of electromagnetic radiation of the target wavelength or wavelength range (e.g., from 850 nm to 950 nm, 905 nm). For example, Si₃N₄ only negligibly absorbs electromagnetic radiation in the 700 nm to 2000 nm wavelength range.

This general insensitivity allows the scratch resistant layer of the higher refractive index material 40 in the first layered film 36 to have a thickness predetermined to meet specified hardness or scratch resistance requirements. For example, the first layered film 36 for the window 24 utilized at the roof 14 of the vehicle 10 may have different hardness and scratch resistance requirements than the first layered film 36 for the window 24 utilized at the forward portion 16 of the vehicle 10, and thus a different thickness for the scratch resistant layer of the higher refractive index material 40. This can be achieved without significant altering of the transmittance and reflectance properties of the first layered film 36 as a whole.

The hardness of the first layered film 36, and thus the window 24, with the scratch resistant layer of the higher refractive index material 40 can be quantified. In embodiments, the maximum hardness of the window 24, measured at the first layered film 36 with the scratch resistant layer of the higher refractive index material 40, as measured by the Berkovich Indenter Hardness Test, may be about 8 GPa or greater, about 10 GPa or greater, about 12 GPa or greater, about 14 GPa or greater, about 15 GPa or greater, about 16 GPa or greater, or about 18 GPa or greater at one or more indentation depths from 50 nm to 2000 nm (measured from the terminal surface 44), and even from 2000 nm to 5000 nm. As used herein, the “Berkovich Indenter Hardness Test” includes measuring the hardness of a material on a surface thereof by indenting the surface with a diamond Berkovich indenter. The Berkovich Indenter Hardness Test includes indenting the terminal surface 44 of the first layered film 36 with the diamond Berkovich indenter to form an indent to an indentation depth in the range from about 50 nm to about 2000 nm (or the entire thickness of the first layered film 36) and measuring the maximum hardness from this indentation along the entire indentation depth range or a segment of this indentation depth range (e.g., in the range from about 100 nm to about 600 nm), generally using the methods set forth in Oliver, W. C.; Pharr, G. M. An improved technique for determining hardness and elastic modulus using load and displacement sensing indentation experiments. J. Mater. Res., Vol. 7, No. 6, 1992, 1564-1583; and Oliver, W. C.; Pharr, G. M. Measurement of Hardness and Elastic Modulus by Instrument Indentation: Advances in Understanding and Refinements to Methodology. J. Mater. Res., Vol. 19, No. 1, 2004, 3-20. These levels of hardness improve the resistance of the window 24 to impact damage from sand, small stones, debris, and other objects encountered while the LIDAR system 12 is used for its intended purpose, such as with the vehicle 10 (see FIG. 1). Accordingly, these levels of hardness reduce or prevent the optical scattering and reduced performance of the LIDAR system 12 that the impact damage would otherwise cause.

In embodiments, at least a portion of the first layered film 36 is disposed between the scratch resistant layer of the higher refractive index material 40 and the terminal surface 44. In embodiments, the first layered film 36 comprises a plurality of alternating layers of the one or more lower refractive index materials 42 and the one or more higher refractive index materials 40 between the terminal surface 44 and the scratch resistant layers. Such a stack of alternating layers disposed between the scratch resistant layer and the terminal surface 44 is described herein as the “optical control layers.” In embodiments, the optical control layers, disposed between the scratch resistant layer and the terminal surface 44, have a combined thickness of greater than or equal to 500 nm (e.g., greater than or equal to 600 nm, greater than or equal to 700 nm, greater than or equal to 800 nm, greater than or equal to 900 nm, greater than or equal to 1000 nm, greater than or equal to 1100 nm, greater than or equal to 1200 nm, greater than or equal to 1300 nm). The quantity, composition, and thickness of the optical control layers may be selected to provide desired anti-reflection performance attributes described herein at an operational wavelength of the LIDAR sensor 12 between 850 nm and 950 nm. That way, the second layered film 36 may be designed to provide desirable optical performance characteristics in the visible and/or UV spectrum, as described herein.

In embodiments, at least 25% (e.g., at least 26%, at least 27%, at least 28%, at least 29%, at least 30%) of a thickness 46 of the first layered film 36 is disposed between the scratch resistant layer and the terminal surface 44. It is believed that such a depth of the scratch resistant layer within the first layered film 36 facilitates the first layered film 36 having a relatively high nanoindentation hardness (as measured by the Berkovich Indenter Hardness Test) over a relatively large range of depths within the first layered film 36. In embodiments, the first layered film 36 has a nanoindentation hardness of greater than or equal to 8 GPa from a depth of 50 nm to a depth of 2000 nm within the first layered film 36. In embodiments, the first layered film 36 has a nanoindentation hardness of greater than or equal to 10 GPa from a depth of 100 nm to a depth of 1000 nm within the first layered film 36. In embodiments, the first layered film 36 has a nanoindentation hardness of greater than or equal to 14 GPa from a depth of 400 nm to a depth of 1000 nm within the first layered film 36. Such hardness values facilitate providing scratch and/or damage resistance against flaws having a relatively wide range of depths.

Referring now to FIGS. 4 and 5, the first layered film 36 has a thickness 46, and the second layered film 38 has a thickness 50. The thickness 46 of the first layered film 36, assumed to include the scratch resistant layer of the one or more higher refractive index materials 40, may be about 1 μm or greater while still providing the transmittance and reflectance properties described herein. In embodiments, the thickness 46 is in the range of 1 μm to just over 50 μm, including from about 1 μm to about 10 μm, and from about 2800 nm to about 5900 nm. The lower bound of about 1 μm is approximately the minimum thickness 46 that still provides hardness and scratch resistance to the window 24. The higher bound of thickness 46 is limited by cost and time required to dispose the layers of the first layered film 36 onto the substrate 30. In addition, the higher bound of the thickness 46 is limited to prevent the first layered film 36 from warping the substrate 30, which is dependent upon the thickness of the substrate 30. The thickness 50 of the second layered film 38 can be any thickness deemed necessary to impart the window 24 with the desired transmittance and reflectance properties. In embodiments, the thickness 50 of the second layered film 38 is in the range of about 800 nm to about 7000 nm.

While solving the problem discussed above in the background through imparting hardness, impact, and scratch resistance to the window 24 via the maximized thickness of a higher refractive index material 40, the quantity, thicknesses, number, and materials of the layers of the first layered film 36 and the second layered film are configured to also provide a relatively high transmittance of infrared radiation between 850 nm and 950 nm through the window 24. In embodiments, the thicknesses, number, and materials of the alternating layers of the first and second layered films 36 and 38 are configured so that the window 24 has an average percentage transmittance, calculated over a 50 nm wavelength range of interest centered at a wavelength from 850 nm to 950 nm (e.g., a 20 nm wavelength range of interest centered at 905 nm) of greater than or equal to 90% (e.g., greater than or equal to 91%, greater than or equal to 92%, greater than or equal to 93%, greater than or equal to 94%, greater than or equal to 95%) for light incident on the first surface 32 and the second surface 34 at angles within 15° of normal to the first surface 32 and the second surface 34.

In embodiments, the thicknesses, number, and materials of the alternating layers of the first and second layered films 36 and 38 are configured so that the window 24 has an average reflectance, calculated over a 50 nm wavelength range of interest centered at a wavelength from 850 nm to 950 nm (e.g., a 20 nm wavelength range of interest centered at 905 nm), of less than or equal to 4.0% (e.g., less than or equal to 3.5%, less than or equal to 3.0%, less than or equal to 2.5%, less than or equal to 2.0%, less than or equal to 1.5%, less than or equal to 1.0%) for light incident on the first surface 32 and the second surface 34 at angles within 15° of normal to the first surface 32 and the second surface 34. In embodiments, the number, thicknesses, number, and materials of the alternating layers of the first and second layered films 36 and 38 are configured so that the window has an average P polarization transmittance and an average S polarization transmittance, calculated over a 50 nm wavelength range of interest centered at a wavelength from 850 nm to 950 nm (e.g., a 20 nm wavelength range of interest centered at 905 nm), of greater than 85% (e.g., greater than or equal to 86%, greater than or equal to 87%, greater than or equal to 88%, greater than or equal to 89%, greater than or equal to 90%, greater than or equal to 91%, greater than or equal to 92%) for light incident on the first surface 32 and the second 34 surface at angles within 60° of normal (e.g., at angles of incidence from 0° to 60°, from 0° to 50°, from 0° to 40°, from 0° to) 30° to the first surface 32 and the second surface 34. Herein, the term “reflectance” is defined as the percentage of incident optical power within a given wavelength range that is reflected from a material (e.g., the window 24, the substrate 30, the first layered film 36, second layered film 38, or portions thereof).

In embodiments, the thicknesses, number, and materials of the alternating layers of the first and second layered films 36 and 38 are configured so that the window 24 has an average percentage transmittance, calculated over a 50 nm wavelength range of interest centered at a wavelength from 850 nm to 950 nm (e.g., a 20 nm wavelength range of interest centered at 905 nm), of greater than or equal to 95% (e.g., greater than or equal to 95.5%, greater than or equal to 96%, greater than or equal to 96.5%, greater than or equal to 97.5%, greater than or equal to 98%) for light normally incident on the first surface 32 and the second surface 34. Herein, the term “transmittance” and “percentage transmission” are used interchangeably ad refer to the percentage of incident optical power within a given wavelength range transmitted through a material (e.g., the window 24, the substrate 30, the first layered film 36, the second layered film 38 or portions thereof).

In embodiments, the thicknesses, number, and materials of the alternating layers of the first and second layered films 36 and 38 are configured so that the window 24 also (in addition to meeting the optical performance requirements in the infrared described herein) has a desired dark appearance. For example, when viewed from the external environment 26 (see FIG. 1), the window 24 may exhibit CIELAB color space a* values that are greater than or equal to −6.0 and less than or equal to 6.0 (e.g., greater than or equal to −5.0 and less than or equal to 5.0, greater than or equal to −4.0 and less than or equal to 4.0, greater than or equal to −3.0 and less than or equal to 3.0, greater than or equal to −2.5 and less than or equal to 2.5, greater than or equal to −2.5 and less than or equal to 0) for light having angles of incidence on the first surface 32 ranging from 0° to 90°. The window 24 may also exhibit CIELAB color space b* values that are greater than or equal to −6.0 and less than or equal to 6.0 (e.g., greater than or equal to −5.0 and less than or equal to 5.0, greater than or equal to −4.0 and less than or equal to 4.0, greater than or equal to −3.0 and less than or equal to 3.0, greater than or equal to −2.5 and less than or equal to 2.5, greater than or equal to −2.5 and less than or equal to 0) for light having angles of incidence on the first surface 32 ranging from 0° to 90°. Such color space values may be obtained even in embodiments where the substrate 30 is has a relatively high transmittance (e.g., greater than 90%) and low reflectance (e.g., less than or equal to 22%) throughout the visible spectrum.

In embodiments, the thicknesses, number, and materials of the alternating layers of the first and second layered films 36 and 38 are configured so that the window 24 has a CIELAB lightness L* value of less than 45 (e.g., less than or equal to 40, less than or equal to 35, less than or equal to 30) when viewed from angles of incidence of less than or equal to 60°. In embodiments, the thicknesses, number, and materials of the alternating layers of the first and second layered films 36 and 38 are configured so that the window 24 has a CIELAB lightness L* value of less than 20 for light that is normally incident on the first layered film 36 and reflected. The aforementioned combination of CIELAB color space and lightness values represent that the window 24 has a relatively dark appearance from a variety of angles of incidence.

The dark appearance of the window 24 may be achieved by incorporating silicon (e.g., as a-Si) or other suitable material that absorbs in the visible spectrum (herein referred to as “absorber layer”) as one of the one or more higher refractive index materials 40 in the second layered film 38. Silicon is suitable for an absorber layer because, in addition to having a relatively high refractive index (approximately 4.0 at 905), silicon has a relatively high optical absorption in the ultraviolet range and visible light range. The thicknesses and quantity of layers of silicon, along with the other layers of the first layered film 36 and second layered film 38 can thus provide a window 24 with low percentage transmittance of electromagnetic radiation in the ultraviolet range and visible light range (due in part to the optical absorbance of the amorphous at those wavelength ranges) but high percentage transmittance in the desired portions of the infrared range. In embodiments, the second layered film 38 includes one or more layers of silicon (e.g., as a-Si) as one of the one or more higher refractive index materials 40 while the first layered film 36 does not. Such a structure may be beneficial in that silicon is solely located behind the substrate 30 and thus protected from the external environment 26. As a result, the nanoindentation hardness values described herein may be obtained via incorporation of the scratch resistance layer into the first layered film 36 while the dark appearance may be obtained via incorporation of silicon into the second layered film 38.

In embodiments, the silicon material used to form at least one of the one or more layer of higher refractive materials 40 is modified to facilitate achieving relatively high optical transmittance over the 50 nm wavelength of interest centered about a wavelength from 850 nm to 950 nm. Particularly, it has been found that the silicon material (or other suitable material that absorbs more radiation in the visible spectrum at higher amounts than the other higher index materials 40 described herein) should have an extinction coefficient of less than or equal to 0.01 (e.g., less than or equal to 0.009, less than or equal to 0.008, less than or equal to 0.007, less than or equal to 0.005, less than or equal to 0.004, less than or equal to 0.0035, less than or equal to 0.0030, less than or equal to 0.0025, less than or equal to 0.0020, less than or equal to 0.0015, less than or equal to 0.0010) at a wavelength within the wavelength range of interest (the wavelength may range from 890 nm to 910 nm in some embodiments, and, in various embodiments, be approximately 890 nm, 891 nm, 892 nm, 893 nm, 894 nm, 895 nm, 896 nm, 897 nm, 898 nm, 899 nm, 900 nm, 901 nm, 902 nm, 903 nm, 904 nm, 905 nm, 906 nm, 907 nm, 908 nm, 909 nm, and 910 nm, and any and all ranges including any of these values as endpoints, with the wavelength to a peak operating wavelength associated with at least one of the emitter and sensor 18). In embodiments, it is preferrable that the silicon material have an extinction coefficient of less than 0.005 at the wavelength, while simultaneously exhibiting a relatively higher extinction coefficient (e.g., greater than or equal to 0.06 greater than or equal to 0.07, greater than or equal to 0.08, greater than or equal to 0.09, greater than or equal to 0.1) throughout the visible spectrum. Such low extinction coefficient within the 50 nm wavelength range of interest and relatively high extinction coefficient throughout the visible spectrum facilitates adding silicon in sufficient amounts to reduce visible transmission to the ranges described herein without significantly effecting the transmittance within the wavelength range of interest.

In embodiments, the alternating layers of the second layered film 38 formed of silicon have a combined thickness of greater than or equal to 250 nm (e.g., greater than or equal to 300 nm, greater than or equal to 325 nm, greater than or equal to 350 nm, greater than or equal to 375 nm, greater than or equal to 400 nm, greater than or equal to 450 nm, greater than or equal to 500 nm, greater than or equal to 550 nm, greater than or equal to 600 nm, greater than or equal to 650 nm, greater than or equal to 700 nm). In embodiments, the combined thickness of the silicon layers in the second layered film constitutes at least 20% (e.g., at least 25%, at least 30%, at least 35%, at least 40%, at least 45%, at least 50%) of the thickness 50 of the second layered film 50. Applicant has found that such a thickness of silicon sufficiently absorbs visible light such that the window 24 possess an average percentage transmission, calculated from 400 nm to 700 nm, of less than 5% (e.g., less than or equal to 4.5%, less than or equal to 4.0%, less than or equal to 3.5%, less than or equal to 3.0%, less than or equal to 2.5%, less than or equal to 2.0%, less than or equal to 1.5%, less than or equal to 1.0% less than or equal to 0.9%, less than or equal to 0.8%, less than or equal to 0.7%, less than or equal to 0.6%, less than or equal to 0.5%, less than or equal to 0.4%, less than or equal to 0.3%, less than or equal to 0.2%, less than or equal to 0.1%) for light incident on the first surface 32 and the second surface 34 at angles within 15° of normal to the first surface 32 and the second surface 34. As such, portions of the reflected radiation 28 (see FIG. 2) containing visible light do not reach the emitter and sensor 18, thereby improving the signal-to-noise ratio of the LIDAR system 12.

In embodiments, the second layered film 36 comprises two or more layers formed from silicon. In embodiments, at least one of the two or more layers formed from silicon comprises a thickness of greater than or equal to 150 nm (e.g., greater than or equal to 160 nm, greater than or equal to 170 nm, greater than or equal to 180 nm, greater than or equal to 190 nm, greater than or equal to 200 nm). In embodiments, at least two, but less than all, of the two or more layers formed from silicon in the second layered film 36 comprises thicknesses of greater than or equal to 150 nm. In embodiments, at least seven (7) of the alternating layers of the second layered film 38 are disposed between one of the silicon layers having a thickness of 150 nm or more and the second surface 34. In embodiments, silicon layers contained in the second layered film 38 comprising thicknesses that are less than 150 nm from the second surface 34 comprise thicknesses of less than or equal to 70 nm (e.g., less than or equal to 65 nm, less than or equal to 60 nm, less than or equal to 55 nm, less than or equal to 50 nm, less than or equal to 30 nm, less than or equal to 25 nm, less than or equal to 20 nm). It is believed that such separation between the substrate 30 and the relatively thick silicon layers aids in reducing reflectance in the visible spectrum.

In embodiments, the alternating layers of the first and second layered films 36 and 38 are constructed to achieve a relatively low average reflectance in the visible spectrum. For example, in embodiments, the window comprises an average reflectance, computed in a wavelength range from 400 nm to 700 nm, of less than or equal to 10% (e.g., less than or equal to 9%, less than or equal to 8%, less than or equal to 7%). Such low reflectance beneficially prevents the window 24 from having a tinted appearance when viewed from the external environment 26 (see FIG. 1) and facilitates achieving the CIE color space a* and b*, and lightness L* values described herein.

In embodiments, to limit the reflectance in the visible spectrum of the window, a silicon layer of the second layered film 38 most proximate to the substrate 30 is the narrowest silicon layer in the second layered film 38. That is, of the layers in the second layered film 38 where the one or more higher refractive index materials 40 is silicon, the closest one to the substrate 30 comprises the least thickness. In embodiments, the nearest silicon layer in the second layered film 38 comprises a thickness that is less than or equal to 15 nm (e.g., less than or equal to 10 nm, less than or equal to 8 nm, less than or equal to 7 nm, less than or equal to 6 nm, less than or equal to 5 nm, less than or equal to 4 nm, less than or equal to 3 nm, less than or equal to 2 nm). Applicant has found that such structure beneficially prevents the silicon-containing layers in the second layered film 38 from inducing a tinted reflectance, while still contributing to the relatively low visible transmittance values described herein.

In embodiments, the layer of the one or more higher refractive index materials 40 that is closest to the substrate 30 in the second layered film 38 is not silicon. In embodiments, for example, the layer of the one or more higher refractive index materials 40 that is closest to the substrate 30 may be constructed of the same higher refractive index material used in the first layered film (e.g., SiNₓ, SiOₓN_{y}, Si₃N₄). In embodiments, the layer of the one or more higher refractive index materials 40 that is closest to the substrate 30 in the second layered film 38 is the only higher index layer therein that is not constructed of silicon. Without wishing to be bound by theory, Applicant believes that such a structure may aid in reducing reflectance in the visible spectrum when incorporating silicon into the second layered film 38, especially when the silicon layers contained in the second layered film 38 comprise thicknesses greater than or equal to 8 nm.

The layers of the first layered film 36 and the second layered film 38 (i.e., layers of the higher refractive index material 40 and the lower refractive index material 42) may be formed by any known method in the art, including discrete deposition or continuous deposition processes. In one or more embodiments, the layer may be formed using only continuous deposition processes, or, alternatively, only discrete deposition processes.

### EXAMPLES

The following examples are all modeled examples using computer facilitated modeling to demonstrate how the quantity, thicknesses, number, and materials of the layers of the first layered film 36 and the second layered film 38 can be configured so that the window 24 has a desired average percentage transmittance and average percentage reflectance as a function of the wavelength and angle of incidence of the incident electromagnetic radiation.

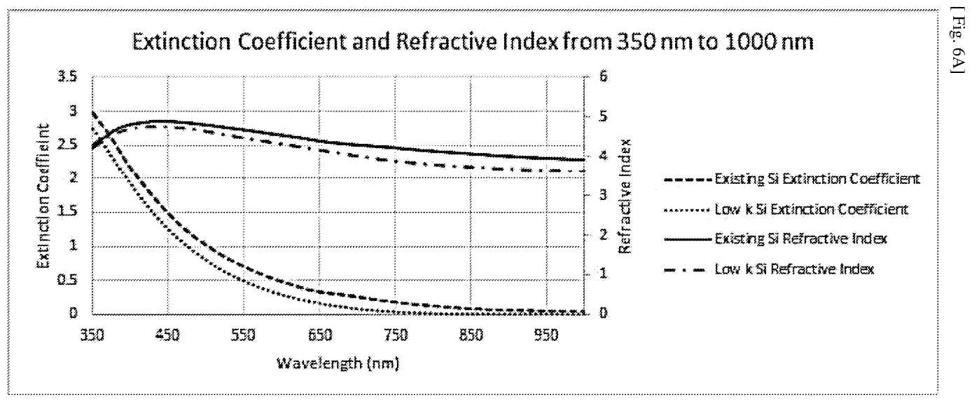

Example 1—the window 24 of Example 1 included a first layered film 36 and a second layered film 38. The second layered film 38 included layers of a silicon material having represented as the “Low k” material in FIGS. 6A-6B. The Low k material was supported amorphous silicon and formed via a similar method as the existing material, but process conditions were altered during the deposition process. As shown, the Low k material exhibits an extinction coefficient that is shifted downward from that of certain existing silicon materials throughout the wavelength range of 350 nm to 1000 nm. As a result, the Low k material exhibits have an extinction coefficient of less than or equal to 0.01 (e.g., in this specific example, less than or equal to 0.004) throughout the wavelength range of 850 nm to 950 nm. Throughout the wavelength range of 890 nm to 910 nm, the Low k silicon exhibits an extinction coefficient of less than 0.002 (approximately 0.0016 at 905 nm). This is a reduction of over an order of magnitude as compared to the existing silicon material, which had extinction coefficients greater than or equal to 0.044 throughout the wavelength range of 850 nm to 950 nm. Moreover, as shown in FIG. 6A, the extinction coefficient of the Low k material is comparable (differs by less than an order of magnitude) to that of the existing silicon material over the wavelength range of 400 nm to 700 nm. From 400 nm to 700 nm, the Low k material exhibits an extinction coefficient ranging from 0.078 to 1.92. Such relatively high extinction coefficients within the visible spectrum enables the Low k silicon material to be incorporated in sufficient quantities to absorb visible light and provide the dark, opaque appearance described herein, while the relatively low extinction coefficient allows such quantities to be introduced without adversely effecting transmission in the 50 nm wavelength range of interest to a significant degree.

The window 24 of Example 1 included a first layered film 36 over a first surface 32 of a substrate 30 of an aluminosilicate glass (Corning code 2320). The window 24 also included a second layered film 38 over a second surface 34 of the substrate 30. The first layered film 36 included thirty-three (33) alternating layers of SiO₂ as the lower refractive index material 42 and SiN as the higher refractive index material 40. Layer 24 was the scratch resistant layer of the higher refractive index material 40, having a thickness of 2000 nm. Layers 1-23 were optical control layers having a combined thickness of 1307.01 nm separating the scratch resistant layer from the terminal surface 44. Layers 25-33 were index matching layers separating the scratch resistance layer from the first surface 32 and having a combined thickness of 338.45 nm. In this example, the scratch resistant layer constituted 54.86% of the thickness of the first layered film 36.

The second layered film 38 included twenty-three (23) alternating layers of the lower refractive index material 42 and the higher refractive index material 40. In this example, the lower refractive index material 42 was SiO₂, while the higher refractive index material 40 was a combination of SiN and Si. As shown, layers 35, 37, 39, and 41—the four closest layers of the higher refractive index material 40 to the substrate 30—were SiN, while the remaining layers of the higher refractive index material 40 were the Low k Si. Layer 43—the Si layer most proximate to the substrate 30—was the narrowest Si layer, with a thickness of 12.04 nm. The combined thickness of the silicon layers was 708.4 nm, which constituted 46.6% of the total thickness of the second layered film 38.

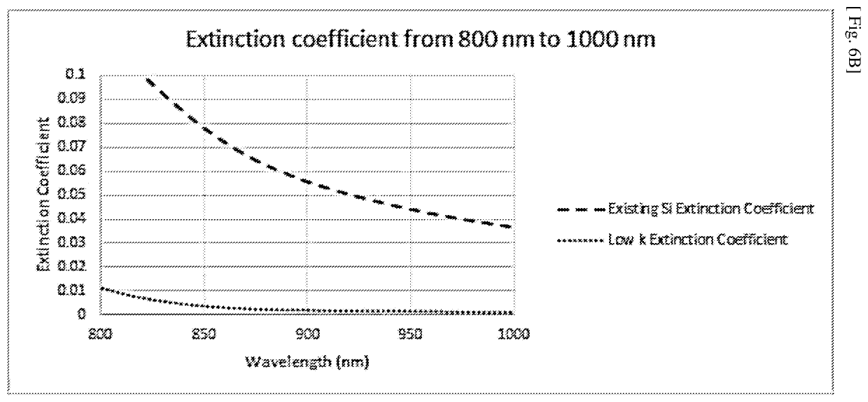

The thicknesses of the layers of the first layered film 36 and the second layered film 38 were configured as set forth in Table 1 below and used to calculate the transmittance, reflectance. CIELAB color space and lightness values of reflection, and nanoindentation hardness values set forth in FIGS. 7-12.

TABLE 1
Example 1 Layer Design

| | | Refractive | Physical |
|---|---|---|---|
| | | Index | Thickness |
| Layer | Material | @905 nm | (nm) |
| Medium | Air | 1 | |
| | Perfluoropolyether | 1-4 | 4-8 |
| 1 | SiO2 | 1.4603 | 117.94 |
| 2 | SiN | 2.0669 | 30.77 |
| 3 | SiO2 | 1.4603 | 19.42 |
| 4 | SiN | 2.0669 | 97.14 |
| 5 | SiO2 | 1.4603 | 22.98 |
| 6 | SiN | 2.0669 | 23.02 |
| 7 | SiO2 | 1.4603 | 191.56 |
| 8 | SiN | 2.0669 | 19.36 |
| 9 | SiO2 | 1.4603 | 30.73 |
| 10 | SiN | 2.0669 | 159.88 |
| 11 | SiO2 | 1.4603 | 31.34 |
| 12 | SiN | 2.0669 | 26.75 |
| 13 | SiO2 | 1.4603 | 93.35 |
| 14 | SiN | 2.0669 | 8.24 |
| 15 | SiO2 | 1.4603 | 83.77 |
| 16 | SiN | 2.0669 | 25.05 |
| 17 | SiO2 | 1.4603 | 28.03 |
| 18 | SiN | 2.0669 | 38.60 |
| 19 | SiO2 | 1.4603 | 12.14 |
| 20 | SiN | 2.0669 | 170.54 |
| 21 | SiO2 | 1.4603 | 11.77 |
| 22 | SiN | 2.0669 | 52.41 |
| 23 | SiO2 | 1.4603 | 12.22 |
| 24 | SiN | 2.0669 | 2000.00 |
| 25 | SiO2 | 1.4603 | 16.07 |
| 26 | SiN | 2.0669 | 47.91 |
| 27 | SiO2 | 1.4603 | 37.02 |
| 28 | SiN | 2.0669 | 34.66 |
| 29 | SiO2 | 1.4603 | 65.63 |
| 30 | SiN | 2.0669 | 17.73 |
| 31 | SiO2 | 1.4603 | 85.09 |
| 32 | SiN | 2.0669 | 9.34 |
| 33 | SiO2 | 1.4603 | 25.00 |
| Substrate | Aluminosilicate glass (2320) | 1.4916 | 2000000.0 |
| 34 | SiO2 | 1.4603 | 25.00 |
| 35 | SiN | 2.0669 | 19.88 |
| 36 | SiO2 | 1.4603 | 37.66 |
| 37 | SiN | 2.0669 | 48.50 |
| 38 | SiO2 | 1.4603 | 16.37 |
| 39 | SiN | 2.0669 | 187.70 |
| 40 | SiO2 | 1.4603 | 23.07 |
| 41 | SiN | 2.0669 | 63.06 |
| 42 | SiO2 | 1.4603 | 15.30 |
| 43 | Si | 3.6748 | 12.04 |
| 44 | SiO2 | 1.4603 | 21.17 |
| 45 | Si | 3.6748 | 27.79 |
| 46 | SiO2 | 1.4603 | 11.08 |
| 47 | Si | 3.6748 | 104.41 |
| 48 | SiO2 | 1.4603 | 17.20 |
| 49 | Si | 3.6748 | 186.33 |
| 50 | SiO2 | 1.4603 | 8.10 |
| 51 | Si | 3.6748 | 182.97 |
| 52 | SiO2 | 1.4603 | 14.50 |
| 53 | Si | 3.6748 | 169.94 |
| 54 | SiO2 | 1.4603 | 62.22 |
| 55 | Si | 3.6748 | 24.92 |
| 56 | SiO2 | 1.4603 | 240.11 |
| Medium | Air | 1 | |

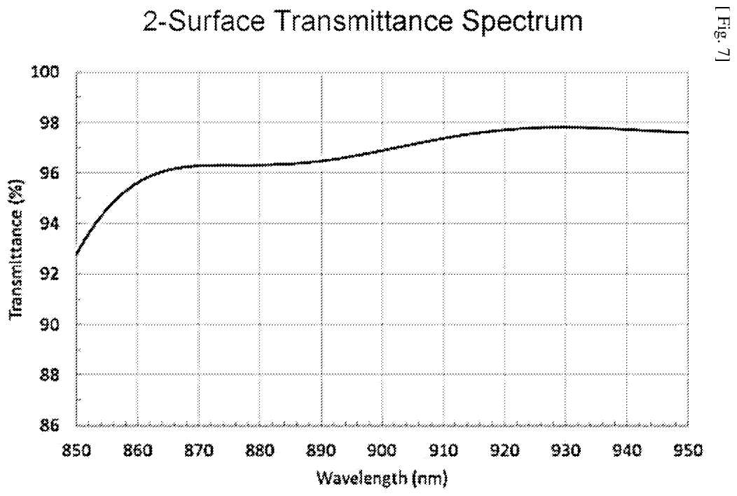

FIG. 7 is a plot of a modelled transmittance of the window 24 according to Example 1 of light that is incident on the window 24 at a 15° angle of incidence throughout the spectral range of 850 nm to 950 nm. As revealed in FIG. 7, the quantity, thicknesses, number, and materials of the first layered film 36 and the second layered film 38 have been configured so that the window 24 of Example 1 has a percentage transmittance of above 93 percent for light incident on the first surface 32 or the second surface 34 at angles of incidence of less than 15° throughout a wavelength range extending from 850 nm to 950 nm. Indeed, throughout the wavelength range of 850 nm to 950 nm, the window exhibits a transmittance of greater than 93% for light at a 15° angle of incidence. The transmittance is greater than 95% throughout the wavelength range of 860 nm to 950 nm. At 905 nm, the transmittance is about 97%. As revealed in FIG. 8, the quantity, thicknesses, number, and materials of the first layered film 36 and the second layered film 38 have been configured so that the window 24 of Example 1 has an average P polarization transmittance and an average S polarization transmittance, calculated a wavelength range of interest from 850 nm to 950 nm, of greater than 89% for light incident on the first surface and the second surface at angles within 60° of normal to the first surface and the second surface. Throughout the wavelength range of 890 nm to 910 nm, the S and P polarization transmittances are greater than 91%.

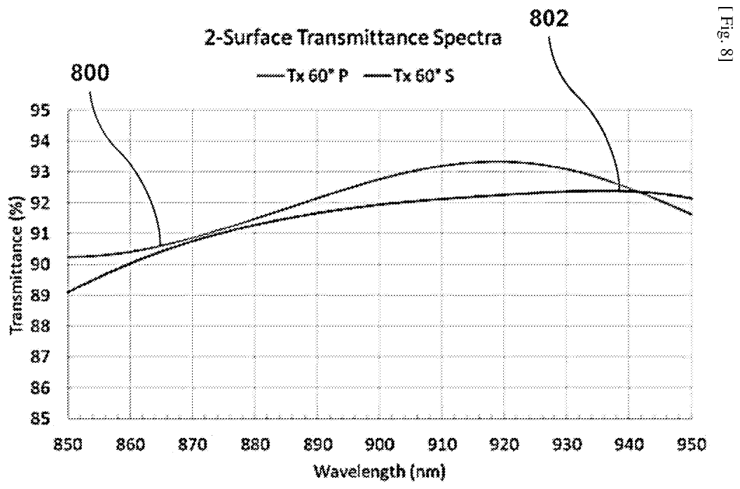

As revealed in FIG. 9, the quantity, thicknesses, number, and materials of the first layered film 36 and the second layered film 38 have been configured so that the window 24 of Example 1 has a percentage reflectance off of the terminal surface 44 of the first layered film 36 and the terminal surface 48 of the second layered film 38 of under 4 percent for light incident on the substrate 300 at an angle of incidence of 15° within the approximate wavelength range of 850 nm to 950 nm. The reflectance from the terminal surface 44 is comparable to that from the terminal surface 48, as the first and second layered films 36 and 38 were constructed of materials having relatively low absorbance in the referenced wavelength range. As shown, throughout the wavelength range of 860 nm to 950 nm, the reflectance is less than 1.6%. Within the wavelength range of 850 nm to 950 nm, the reflectance has a minimum value of approximately of less than 1.0% (approximately 0.8%) at a wavelength of 925 nm.

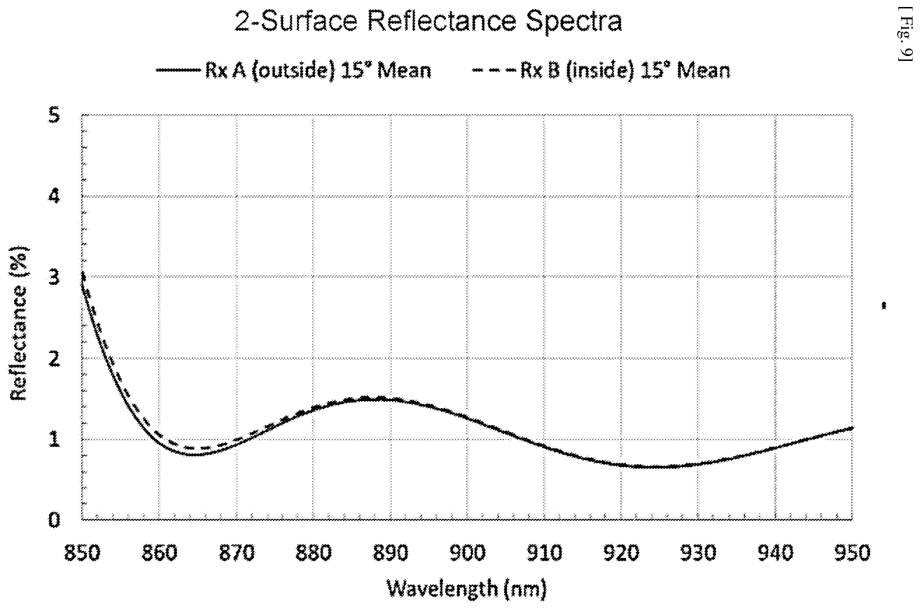

As revealed in FIG. 10, the quantity, thicknesses, number, and materials of the first layered film 36 and the second layered film 38 have been configured so that the window 24 of Example 1 has a transmittance less than 12% throughout the visible spectrum for light incident on the window 24 at angles of incidence of less than or equal to 15°. From 400 nm to 650 nm, the transmittance in the visible spectrum is less than 3%. For wavelengths less than 600 nm, the transmittance in the visible spectrum is less than 0.2%. It is believed that these low transmission values are due in part to the absorbance of visible light by the silicon layers in the second layered film 38. The window 24 exhibits an average transmittance that is less than or equal to 5.0% over the wavelength range of 400 nm to 700 nm.

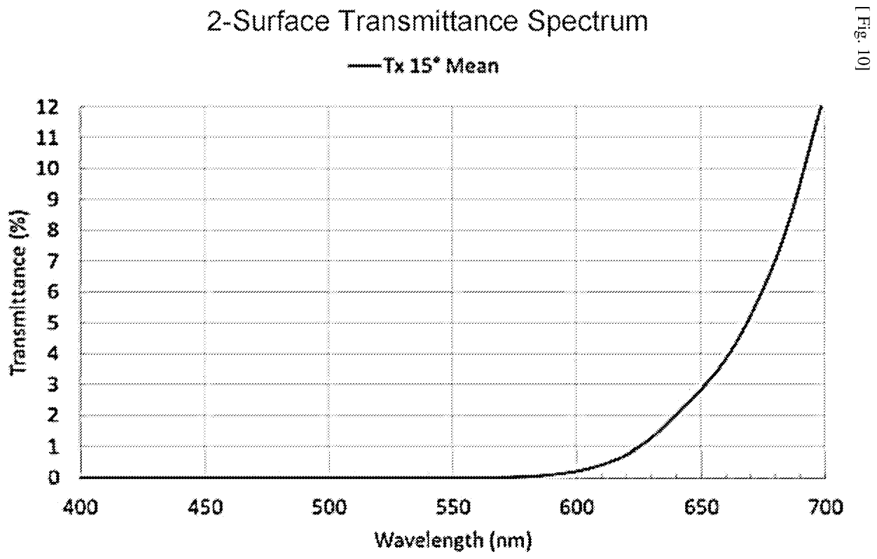

As revealed in FIGS. 11A and 11B, the quantity, thicknesses, number, and materials of the first layered film 36 and the second layered film 38 have been configured so that the window 24 of Example 1 has a dark appearance when viewed from the terminal surface 44 of the first layered film. FIG. 11 provides simulated CIELAB reflected color data for Example 1 for light reflected off of the terminal surface 44. The color of the reflected light can be characterized using CIELAB color coordinates. The a* axis in color space is representative of the green-red color component, with negative a* values corresponding to green and positive a* values corresponding to red. The b* axis in color space is representative of the blue-yellow component, with negative b* values corresponding to blue and positive b* values corresponding to yellow. The closer the a* and b* values are to the origin, the more neutral in color the reflected light will appear to an observer. The CIELAB a* and b* values were generated by simulating an illuminant source at a plurality of different angles of incidence, ranging from 0° to 90°. As shown, the a* values ranges from about 0 to about 4.5, while the b* values ranges from about −0.8 to about 0.8. This indicates that the window 24 according to example 1 has a neutral appearance when viewed form the external environment 26 (see FIG. 1).

FIG. 11B depicts modelled CIELAB lightness L* values of reflection as a function of angle of incidence on the terminal surface 44. As shown, for angles of incidence less than or equal to 60°, the lightness L* value is less than or equal to 35. For angles of incidence less than or equal to 50°, the lightness L* value is less than or equal to 25. For angles of incidence less than or equal to 35°, the lightness L* value is less than or equal to 20. This indicates that the window 24 according to example 1 has a dark appearance when viewed form the external environment 26 (see FIG. 1).

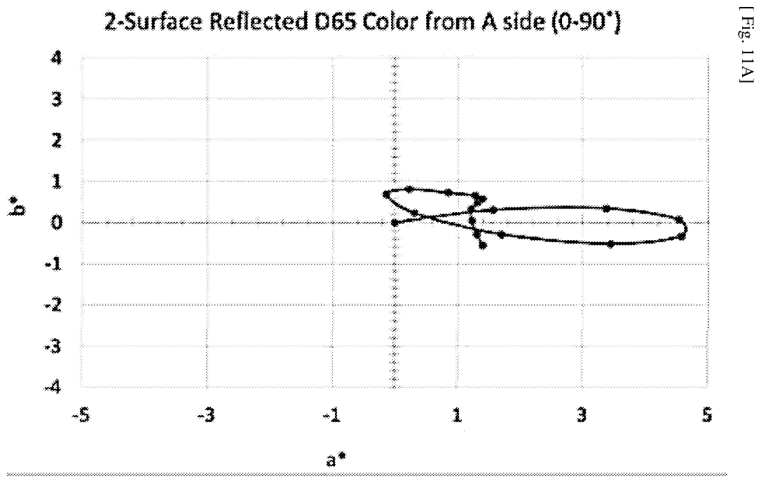

FIG. 12 reveals nanoindentation hardness measured as a function of depth for a sample constructed in accordance with Example 1 herein. The hardness values were simulated as being subjected to the Berkovich Indenter Hardness Test described herein on the side of the first layered film 36. The sample was measured for a range of depths form 50 nm to 1000 nm. As depicted in FIG. 12, the sample exhibited a maximum hardness at approximately 750 nm in depth of greater than 15.5 GPa. Without wishing to be bound by theory, it is believed that the maximum hardness lies above the scratch resistant layers due to the stress fields caused by the indenter propagating beneath the scratch resistant layer once the depth reaches 1050 nm. As demonstrated by FIG. 12, the window 24 according to Example 1 exhibits a nanoindentation hardness of greater than 8 GPa throughout a depth range of 50 nm to 1000 nm. The window 24 according to Example 1 also exhibits a nanoindentation hardness of greater than 10 GPa throughout a depth range of 100 nm to 1000 nm. The window 24 according to Example 1 also exhibits a nanoindentation hardness of greater than 12 GPa throughout a depth range of 200 nm to 1000 nm. The window 24 according to Example 1 also exhibits a nanoindentation hardness of greater than 14 GPa throughout a depth range of 400 nm to 1000 nm. The window 24 according to Example 1 also exhibits a nanoindentation hardness of greater than 15 GPa throughout a depth range of 600 nm to 1000 nm. This indicates that this example provides favorable scratch/damage resistance for various applications.

Embodiments of the present disclosure can be further understood in view of the following information.

In embodiments, one of the first layered film 36 and the second layered film 38 comprises one or more layers formed of a transparent conductive oxide (“TCO”) material. The TCO material can replace one of the layers of higher refractive index material 40. The layer(s) of TCO material can be communicatively (e.g., conductively) coupled to a power source (not depicted) for heating the window 24. This heating facilitates the one or more LiDAR systems 12 operating in low temperature environments. The TCO material may be selected from suitable optically transparent and electrically conductive materials, such as indium tin oxide (“ITO”), aluminum-doped zinc oxide (“AZO”), and indium-doped cadmium oxide. In embodiments, ITO is preferred due to superior heat durability over certain other existing TCO materials.

In embodiments, the layer(s) of TCO material are disposed in the second layered film 38. In some embodiments, the layer(s) of TCO material are disposed more proximate to the terminal surface 48 than absorber layers (e.g., Si layers) located in the second layered film 38 such that the absorber layers are disposed between the layer(s) of TCO material and the substrate 30. Such a construction beneficially facilitates the addition of the TCO material without effecting the dark, opaque appearance of the window 24 described herein. In aspects, the layer(s) of TCO material are disposed between layers of lower refractive index materials 42 due to the intermediate refractive index thereof. However, embodiments are contemplated in which the layer(s) of TCO material are disposed adjacent to the substrate 30 (e.g., between the substrate 30 and one of the first and second layered films 36 and 38). In aspects, the second layered film 38 comprises a single layer of TCO material (e.g., ITO), with the single layer of TCO material being the layer of the higher refractive index material 40 that is furthest from the substrate 30, with a plurality of absorber (e.g. Si) layers (and/or other layers of the higher refractive index materials 40) being disposed between the layer of TCO material and the substrate 30.

The thickness of the layer(s) of TCO material can be selected based on a number of factors, including a desired a sheet resistance that is necessary to achieve heating of the window 24 and the desired optical performance of the window 24. In embodiments, each of the layers of TCO material has a thickness that is less than or equal to 50 nm (e.g., less than or equal to 45 nm, less than or equal to 40 nm, less than or equal to 35 nm, less than or equal to 30 nm, less than or equal to 25 nm, greater than or equal to 20 nm and less than or equal to 30 nm) and an optical extinction coefficient at 905 nm that is less than or equal to 0.05 (e.g., less than or equal to 0.04). Embodiments where the layer(s) of TCO material have thicknesses greater than 50 nm are also contemplated. When the extinction coefficient is less than 0.05 throughout a spectral range of 840 nm to 1020 nm, absorption over the wavelength range of interest is beneficially minimized to maintain the superior transmission performance of the layered films described herein. That is, the layer(s) of TCO material do not significantly effect the transmittance properties of the window 24 at the wavelength range of interest, while providing adequate sheet resistance to facilitate heating. It has been found that ITO is a suitable TCO material, able to provide suitable sheet resistance for heating when deposited at thicknesses from 20 nm to 30 nm, while having an optical extinction coefficient of less than 0.05 over the wavelength range of interest.

Example 2—the window 24 of Example 2 included a first layered film 36 and a second layered film 38. The second layered film 38 included layers of a silicon material described as the “Low k” material with respect to FIGS. 6A-6B herein. The window 24 of Example 2 included a first layered film 36 over a first surface 32 of a substrate 30. The window 24 also included a second layered film 38 over a second surface 34 of the substrate 30. In Example 2, the substrate 30 was a laminate described in U.S. Provisional Patent Application No. 63/349,764, entitled “Laminate Windows for Infrared Sensing Systems,” filed on Jun. 7, 2022, and hereby incorporated by reference in its entirety. Particularly, the substrate 30 included a first glass ply (as the outer ply away from the radiation emitter and sensor 18) that was a 2.85 mm thick layer of unstrengthened aluminosilicate glass, an interlayer of optically clear adhesive, and a second (inner) glass ply 320 that was a 1 mm thick layer of chemically strengthened aluminosilicate glass.

The first layered film 36 included thirty-one (31) alternating layers of SiO₂ as the lower refractive index material 42 and SiN as the higher refractive index material 40. Layer 22 was the scratch resistant layer of the higher refractive index material 40, having a thickness of 2038.98 nm. Layers 1-21 were optical control layers having a combined thickness of 1352 nm separating the scratch resistant layer from the terminal surface 44. Layers 23-31 were index matching layers separating the scratch resistance layer from the first surface 32 and having a combined thickness of 380.87 nm. In this example, the scratch resistant layer constituted 54.06% of the thickness of the first layered film 36.

The second layered film 38 included twenty-three (23) alternating layers of the lower refractive index material 42 and the higher refractive index material 40. In this example, the lower refractive index material 42 was SiO₂, while the higher refractive index material 40 was a combination of SiN, Si, and ITO. As shown, layers 35, 37, 39, and 41—the four closest layers of the higher refractive index material 40 to the substrate 30—were SiN, while the remaining layers of the higher refractive index material 40 were the Low k Si and ITO. Layer 43—the Si layer most proximate to the substrate 30—was the narrowest Si layer, with a thickness of 12.22 nm. The combined thickness of the silicon layers was 485.01 nm, which constituted 35.9% of the total thickness of the second layered film 38. Layer 55, was a layer of TCO material. As shown, the TCO layer had a refractive index of 1.72 at 905 nm, which is less than half of that of the closest layers of the higher refractive index material 40. The thickness of the TCO layer was 22 nm to provide a desired sheet resistance for heating purposes. The TCO was beneficially located rearward (closer to the terminal surface 48) than the silicon layers. As described herein, such placement of the TCO layer is beneficial because visible light is absorbed by the silicon layers and, as a result, does not reach the TCO layer. The addition of the TCO layer in this manner beneficially prevents the TCO layer from altering the appearance of the window 24 described herein, while also adding functionality.

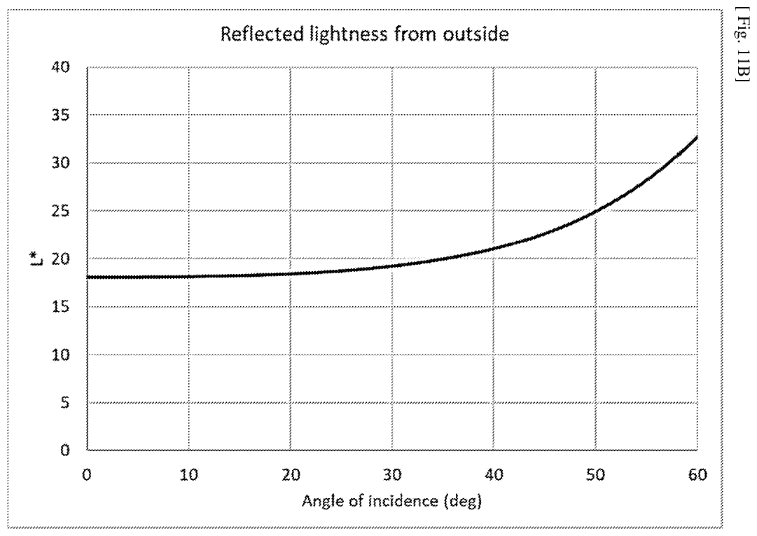

The thicknesses of the layers of the first layered film 36 and the second layered film 38 were configured as set forth in Table 2 below and used to calculate the transmittance, reflectance. CIELAB color space and lightness values of reflection values set forth in FIGS. 13-15.

TABLE 2
Example 2 Layer Design

| | | Refractive | Physical |
|---|---|---|---|
| | | Index | Thickness |
| Layer | Material | @905 nm | (nm) |
| Medium | Air | 1 | |
| | Perfluoropolyether | 1-4 | 4-8 |
| 1 | SiO2 | 1.4603 | 115.98 |
| 2 | SiN | 2.0669 | 33.95 |
| 3 | SiO2 | 1.4603 | 18.3 |
| 4 | SiN | 2.0669 | 97.81 |
| 5 | SiO2 | 1.4603 | 23.04 |
| 6 | SiN | 2.0669 | 24.61 |
| 7 | SiO2 | 1.4603 | 191.22 |
| 8 | SiN | 2.0669 | 17.29 |
| 9 | SiO2 | 1.4603 | 25.43 |
| 10 | SiN | 2.0669 | 164.64 |
| 11 | SiO2 | 1.4603 | 28.29 |
| 12 | SiN | 2.0669 | 25.33 |
| 13 | SiO2 | 1.4603 | 235.11 |
| 14 | SiN | 2.0669 | 28.05 |
| 15 | SiO2 | 1.4603 | 35.81 |
| 16 | SiN | 2.0669 | 37.94 |
| 17 | SiO2 | 1.4603 | 17.32 |
| 18 | SiN | 2.0669 | 145.89 |
| 19 | SiO2 | 1.4603 | 10.93 |
| 20 | SiN | 2.0669 | 58.18 |
| 21 | SiO2 | 1.4603 | 16.88 |
| 22 | SiN | 2.0669 | 2038.98 |
| 23 | SiO2 | 1.4603 | 16.63 |
| 24 | SiN | 2.0669 | 48.52 |
| 25 | SiO2 | 1.4603 | 42.12 |
| 26 | SiN | 2.0669 | 33.29 |
| 27 | SiO2 | 1.4603 | 65.34 |
| 28 | SiN | 2.0669 | 17.74 |
| 29 | SiO2 | 1.4603 | 95.15 |
| 30 | SiN | 2.0669 | 11.52 |
| 31 | SiO2 | 1.4603 | 50.56 |
| Substrate | Aluminosilicate glass (2320) | 1.4985 | 2850000.0 |
| Substrate | Aluminosilicate glass (2320) | 1.4985 | 1000000.0 |
| 34 | SiO2 | 1.4603 | 64.68 |
| 35 | SiN | 2.0669 | 19.99 |
| 36 | SiO2 | 1.4603 | 46.02 |
| 37 | SiN | 2.0669 | 45.11 |
| 38 | SiO2 | 1.4603 | 14.57 |
| 39 | SiN | 2.0669 | 208.21 |
| 40 | SiO2 | 1.4603 | 25.92 |
| 41 | SiN | 2.0669 | 58.70 |
| 42 | SiO2 | 1.4603 | 15.47 |
| 43 | Si | 3.6748 | 12.22 |
| 44 | SiO2 | 1.4603 | 20.58 |
| 45 | Si | 3.6748 | 30.03 |
| 46 | SiO2 | 1.4603 | 13.17 |
| 47 | Si | 3.6748 | 99.03 |
| 48 | SiO2 | 1.4603 | 15.76 |
| 49 | Si | 3.6748 | 145.62 |
| 50 | SiO2 | 1.4603 | 11.33 |
| 51 | Si | 3.6748 | 174.37 |
| 52 | SiO2 | 1.4603 | 69.29 |
| 53 | Si | 3.6748 | 23.74 |
| 54 | SiO2 | 1.4603 | 186.27 |
| 55 | ITO | 1.7187 (550 | 22.00 |
| | | nm) | |
| 56 | SiO2 | 1.4603 | 27.12 |
| Medium | Air | 1 | |

FIG. 13 is a plot of a modelled transmittance of the window 24 according to Example 2 of light that is incident on the window 24 at a 15° angle of incidence and a 60° angle of incidence throughout the spectral range of 350 nm to 1500 nm. As revealed in FIG. 13, the quantity, thicknesses, number, and materials of the first layered film 36 and the second layered film 38 have been configured so that the window 24 of Example 2 has a percentage transmittance of above 95 percent for light incident on the first surface 32 or the second surface 34 at angles of incidence of less than 15° throughout a wavelength range extending from 850 nm to 950 nm. Indeed, throughout the wavelength range of 850 nm to 950 nm, the window exhibits a transmittance of greater than 96% for light at a 15° angle of incidence. Additionally, as shown in FIG. 13, the quantity, thicknesses, number, and materials of the first layered film 36 and the second layered film 38 have been configured so that the window 24 of Example 2 has a polarization-averaged transmittance, calculated a wavelength range of interest from 850 nm to 950 nm, of greater than 89% for light incident on the first surface and the second surface at angles within 60° of normal to the first surface and the second surface.

As is further revealed in FIG. 13, the quantity, thicknesses, number, and materials of the first layered film 36 and the second layered film 38 have been configured so that the window 24 of Example 2 has a transmittance less than 10% throughout the visible spectrum for light incident on the window 24 (the terminal surface 44) at angles of incidence of less than or equal to 15°. The window 24 according to Example 2 exhibits an average transmittance of less than 2% from 400 nm to 700 nm at normal incidence. These low transmission values are due in part to the absorbance of visible light by the silicon layers in the second layered film 38. As is further revealed in FIG. 13, the quantity, thicknesses, number, and materials of the first layered film 36 and the second layered film 38 have been configured so that the window 24 of Example 2 has a transmittance less than 13% throughout the visible spectrum for light incident on the window 24 (the terminal surface 44) at angles of incidence of less than or equal to 60°.

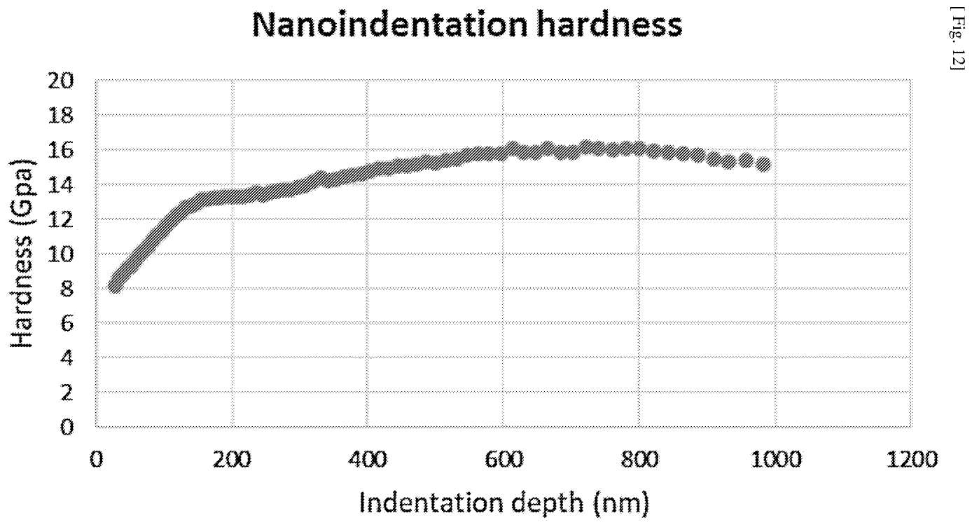

As revealed in FIG. 14, the quantity, thicknesses, number, and materials of the first layered film 36 and the second layered film 38 have been configured so that the window 24 of Example 2 has a polarization-averaged percentage reflectance off of the terminal surface 44 of the first layered film 36 of under 1% for light incident on the substrate 30 at an angle of incidence of 15° within the approximate wavelength range of 850 nm to 950 nm. The reflectance from the terminal surface 44 is comparable to that from the terminal surface 48, as the first and second layered films 36 and 38 were constructed of materials having relatively low absorbance in the referenced wavelength range.

As revealed in FIG. 15, the quantity, thicknesses, number, and materials of the first layered film 36 and the second layered film 38 have been configured so that the window 24 of Example 2 has a dark appearance when viewed from the terminal surface 44 of the first layered film. FIG. 15 provides simulated CIELAB reflected color data for Example 2 for light reflected off of the terminal surface 44. The CIELAB a* and b* values were generated by simulating an illuminant source at a plurality of different angles of incidence, ranging from 0° to 90°. As shown, the a* values ranges from about −1.2 to about 0.8, while the b* values ranges from about −0.3 to about 6. This indicates that the window 24 according to Example 2 has a neutral appearance when viewed form the external environment 26 (see FIG. 1).

It has been found that, in the second layered film 38, separating the silicon layers from the terminal surface 48 with one or more layers of another layer of the higher refractive index materials 40 can provide improve anti-reflective performance in the 50 nm wavelength range of interest, particularly from the terminal surface 48. Accordingly, in embodiments, an innermost silicon layer of the second layered film 38 that is furthest from the substrate 30 (most proximate the terminal surface 48) can be separated from the terminal surface 48 by an “inner AR stack” comprising at least one layer of the lower refractive index materials 42 and at least one layer of the higher refractive index materials 40 that are not silicon (e.g., SiN or other suitable higher refractive index material). When included, the inner AR stack may also be disposed between this innermost silicon layer and the terminal surface 48. While the design according to Example 2 herein exhibits favorable performance, it has been found that the addition of this inner AR stack lowers the reflectance of the window 24 within the 50 nm wavelength range of interest, particularly at lower angles of incidence on the terminal surface 48 that are less than or equal to 15°. The inner AR stack can enable a maximum reflectance that is less than or equal to 0.5% throughout the wavelength range of 890 nm to 950 nm for light incident on the second layered film 38 at angles of incidence that are less than or equal to 15°.

In embodiments, the inner AR stack of the second layered film 38 comprises at least 2 (e.g., at least 3, at least 4) layers of the higher refractive index materials 40 that are not silicon or a TCO layer such that the inner AR stack comprises at least 4 (e.g., at least 6, at least 8) alternating layers of the lower refractive index materials 42 and the higher refractive index materials 40. Moreover, a TCO layer, such as that described herein with respect to Example 2, can be incorporated between the inner AR stack and the terminal surface 48 to facilitate heating without disrupting the appearance of the window 24, as described herein with respect to Example 2.

Example 3—the window 24 of Example 3 included a first layered film 36 and a second layered film 38. The second layered film 38 included layers of a silicon material described as the “Low k” material with respect to FIGS. 6A-6B herein. The window 24 of Example 3 included a first layered film 36 over a first surface 32 of a substrate 30. The window 24 also included a second layered film 38 over a second surface 34 of the substrate 30. In Example 3, the substrate 30 was a laminate described in U.S. Provisional Patent Application No. 63/349,764, entitled “Laminate Windows for Infrared Sensing Systems,” filed on Jun. 7, 2022, and hereby incorporated by reference in its entirety. Particularly, the substrate 30 included a first glass ply (as the outer ply away from the radiation emitter and sensor 18) that was a 2.85 mm thick layer of unstrengthened aluminosilicate glass, an interlayer of optically clear adhesive, and a second (inner) glass ply 320 that was a 1 mm thick layer of chemically strengthened aluminosilicate glass.

The first layered film 36 included thirty-one (31) alternating layers of SiO₂ as the lower refractive index material 42 and SiN as the higher refractive index material 40. Layer 22 was the scratch resistant layer of the higher refractive index material 40, having a thickness of 2038.98 nm. Layers 1-21 were optical control layers having a combined thickness of 1226.23 nm separating the scratch resistant layer from the terminal surface 44. Layers 23-31 were index matching layers separating the scratch resistance layer from the first surface 32 and having a combined thickness of 355.85 nm. In this example, the scratch resistant layer constituted 55.83% of the thickness of the first layered film 36.

The second layered film 38 included thirty-three (33) alternating layers of the lower refractive index material 42 and the higher refractive index material 40. In this example, the lower refractive index material 42 was SiO₂, while the higher refractive index material 40 was a combination of SiN, Si, and ITO. As shown, layers 35, 37, and 39—the three closest layers of the higher refractive index material 40 to the substrate 30—were SiN. Layers 41, 43, 45, 47, 49, 51, 53, 55, and 57 where silicon layers. Layer 41—the Si layer most proximate to the substrate 30—was the narrowest Si layer, with a thickness of 9.55 nm. The combined thickness of the silicon layers was 742.34 nm, which constituted 21.8% of the total thickness of the second layered film 38. Layer 65 was a layer of TCO material. As shown, the TCO layer had a refractive index of 1.54. The TCO was beneficially located rearward (closer to the terminal surface 48) than the silicon layers. As described herein, such placement of the TCO layer is beneficial because visible light is absorbed by the silicon layers and, as a result, does not reach the TCO layer. The addition of the TCO layer in this manner beneficially prevents the TCO layer from altering the appearance of the window 24 described herein, while also adding functionality.

In Example 3, layers 58-64 separate the silicon layers from the TCO layer and represent an inner AR stack, with the inner AR stack including SiN as the higher refractive index material. As shown, three SiN layers separate the innermost silicon layer from the terminal surface 48. The inner AR stack included seven layers with a combined thickness of 1251.11 nm, representing 36.82% of the total thickness of the second layered film 38. As shown, the inner AR stack included the two relatively layers of SiO₂ (lays 58 and 62) having thicknesses greater than 350 nm. Such thick layers aid in providing particularly low reflectance on the inner side of the window 24, preventing back reflections of emitted radiation from causing signal noise.

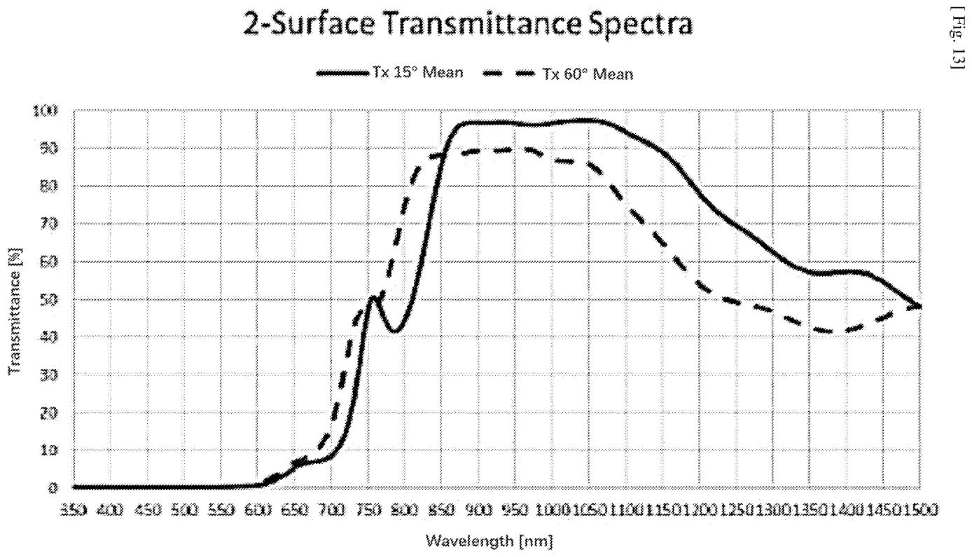

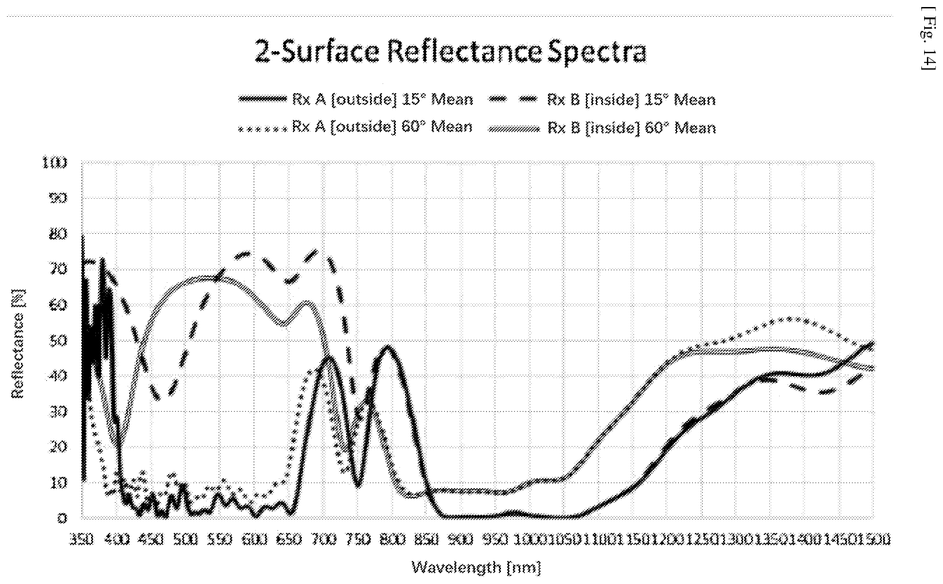

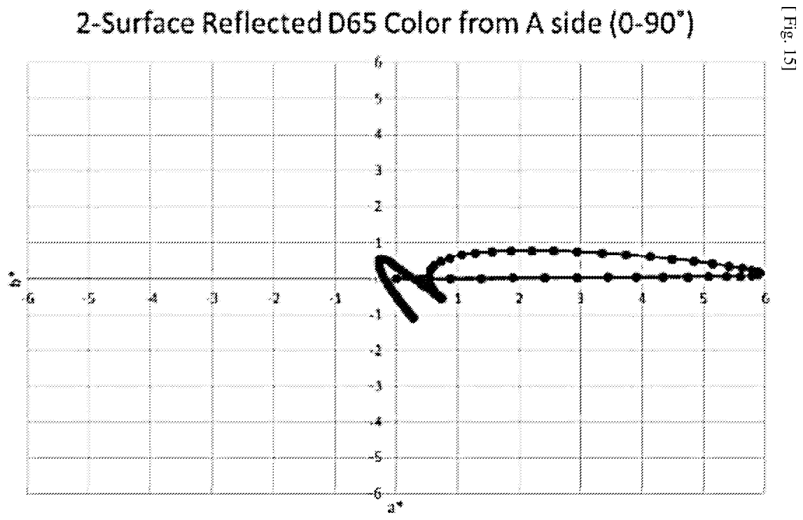

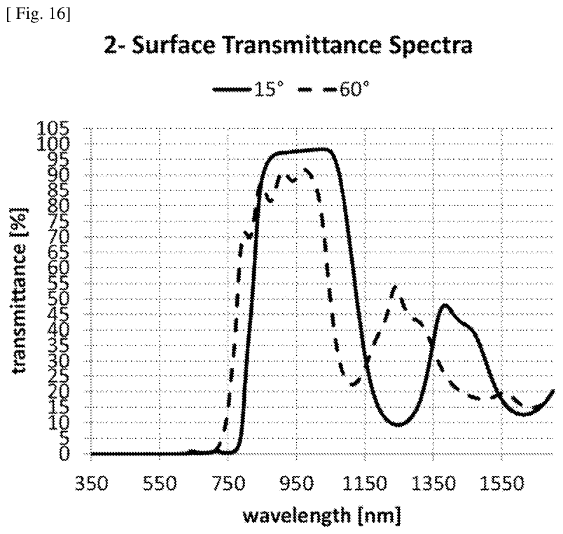

The thicknesses of the layers of the first layered film 36 and the second layered film 38 in Example 3 were configured as set forth in Table 3 below and used to calculate the transmittance, reflectance, CIELAB color space and lightness values set forth in FIGS. 16-18.

TABLE 3
Example 3 Layer Design

| | | Refractive | Physical |
|---|---|---|---|
| | | Index | Thickness |
| Layer | Material | @905 nm | (nm) |
| Medium | Air | 1 | |
| | Perfluoropolyether | 1-4 | 4-8 |
| 1 | SiO2 | 1.4603 | 115.98 |
| 2 | SiN | 2.0669 | 33.95 |
| 3 | SiO2 | 1.4603 | 18.3 |
| 4 | SiN | 2.0669 | 97.81 |
| 5 | SiO2 | 1.4603 | 23.04 |
| 6 | SiN | 2.0669 | 24.61 |
| 7 | SiO2 | 1.4603 | 191.22 |
| 8 | SiN | 2.0669 | 17.29 |
| 9 | SiO2 | 1.4603 | 25.43 |
| 10 | SiN | 2.0669 | 164.64 |
| 11 | SiO2 | 1.4603 | 28.29 |
| 12 | SiN | 2.0669 | 25.33 |
| 13 | SiO2 | 1.4603 | 235.11 |
| 14 | SiN | 2.0669 | 28.05 |
| 15 | SiO2 | 1.4603 | 35.81 |
| 16 | SiN | 2.0669 | 37.94 |
| 17 | SiO2 | 1.4603 | 17.32 |
| 18 | SiN | 2.0669 | 145.89 |
| 19 | SiO2 | 1.4603 | 10.93 |
| 20 | SiN | 2.0669 | 58.18 |
| 21 | SiO2 | 1.4603 | 16.88 |
| 22 | SiN | 2.0669 | 2038.98 |
| 23 | SiO2 | 1.4603 | 16.63 |
| 24 | SiN | 2.0669 | 48.52 |
| 25 | SiO2 | 1.4603 | 42.12 |
| 26 | SiN | 2.0669 | 33.29 |
| 27 | SiO2 | 1.4603 | 65.34 |
| 28 | SiN | 2.0669 | 17.74 |
| 29 | SiO2 | 1.4603 | 95.15 |
| 30 | SiN | 2.0669 | 11.52 |
| 31 | SiO2 | 1.4603 | 50.56 |
| Substrate | Aluminosilicate glass (2320) | 1.4985 | 2850000.0 |
| Substrate | Aluminosilicate glass (2320) | 1.4985 | 1000000.0 |
| 34 | SiO2 | 1.46757 | 25 |
| 35 | SiN | 2.01527 | 8.14 |
| 36 | SiO2 | 1.46757 | 242.94 |
| 37 | SiN | 2.01527 | 14.89 |
| 38 | SiO2 | 1.46757 | 63.26 |
| 39 | SiN | 2.01527 | 60.51 |
| 40 | SiO2 | 1.46757 | 13.57 |
| 41 | Si | 3.67482 | 9.55 |
| 42 | SiO2 | 1.46757 | 25.61 |
| 43 | Si | 3.67482 | 153.9 |
| 44 | SiO2 | 1.46757 | 22.32 |
| 45 | Si | 3.67482 | 105.03 |
| 46 | SiO2 | 1.46757 | 44.02 |
| 47 | Si | 3.67482 | 23.75 |
| 48 | SiO2 | 1.46757 | 465.16 |
| 49 | Si | 3.67482 | 138.17 |
| 50 | SiO2 | 1.46757 | 113.89 |
| 51 | Si | 3.67482 | 42.11 |
| 52 | SiO2 | 1.46757 | 15.28 |
| 53 | Si | 3.67482 | 94.4 |
| 54 | SiO2 | 1.46757 | 56.31 |
| 55 | Si | 3.67482 | 155.71 |
| 56 | SiO2 | 1.46757 | 71.19 |
| 57 | Si | 3.67482 | 19.72 |
| 58 | SiO2 | 1.46757 | 356.34 |
| 59 | SiN | 2.01527 | 264.55 |
| 60 | SiO2 | 1.46757 | 44.11 |
| 61 | SiN | 2.01527 | 90.21 |
| 62 | SiO2 | 1.46757 | 379.05 |
| 63 | SiN | 2.01527 | 99.45 |
| 64 | SiO2 | 1.46757 | 17.4 |
| 65 | ITO | 1.54307 | 22 |
| 66 | SiO2 | 1.46757 | 140.08 |
| Medium | Air | 1 | |

FIG. 16 is a plot of a modelled transmittance (polarization-averaged) of the window 24 according to Example 3 for light that is incident on the window 24 at a 15° angle of incidence and a 60° angle of incidence throughout the spectral range of 350 nm to 1500 nm. As revealed in FIG. 16, the quantity, thicknesses, number, and materials of the first layered film 36 and the second layered film 38 have been configured so that the window 24 of Example 3 has a percentage transmittance of above 95 percent for light incident on the first surface 32 or the second surface 34 at angles of incidence of less than 15° throughout a wavelength range extending from 850 nm to 950 nm. Indeed, throughout the wavelength range of 850 nm to 950 nm, the window exhibits a transmittance of greater than 96% for light at a 15° angle of incidence.

Additionally, as shown in FIG. 16, the quantity, thicknesses, number, and materials of the first layered film 36 and the second layered film 38 have been configured so that the window 24 of Example 3 has a polarization-averaged transmittance, calculated over a wavelength range of interest from 850 nm to 950 nm, of greater than 85% for light incident on the first surface and the second surface at angles within 60° of normal to the first surface and the second surface. Further, as revealed in FIG. 16, the quantity, thicknesses, number, and materials of the first layered film 36 and the second layered film 38 have been configured so that the window 24 of Example 3 has a transmittance less than 5% throughout the visible spectrum for light incident on the window 24 (the terminal surface 44) at angles of incidence of less than or equal to 60°. The window 24 according to Example 3 exhibits an average transmittance of less than 0.1% from 400 nm to 700 nm at normal incidence. The reduced visible transmittance as compared to Example 3 is due to the larger number of silicon layers and the combined thickness of the silicon layers.

As revealed in FIG. 17A, the quantity, thicknesses, number, and materials of the first layered film 36 and the second layered film 38 have been configured so that the window 24 of Example 3 has a polarization-averaged percentage reflectance off of the terminal surface 44 of the first layered film 36 of under 1% for light incident on the substrate 30 at an angle of incidence of 15° within the approximate wavelength range of 850 nm to 950 nm on either of the terminal surfaces 44 and 48. As is revealed in FIG. 17B, the quantity, thicknesses, number, and materials of the first layered film 36 and the second layered film 38 have been configured so that the window 24 of Example 3 has an average percentage reflectance off of both the terminal surface 44 of the first layered film 36 and the terminal surface 48 of the second layered film 38 of under 0.5% for light incident at an angle of incidence of 15° within the approximate wavelength range of 890 nm to 950 nm (polarizations averaged), which is also lower than that of Example 2 due to the addition of the inner AR stack.

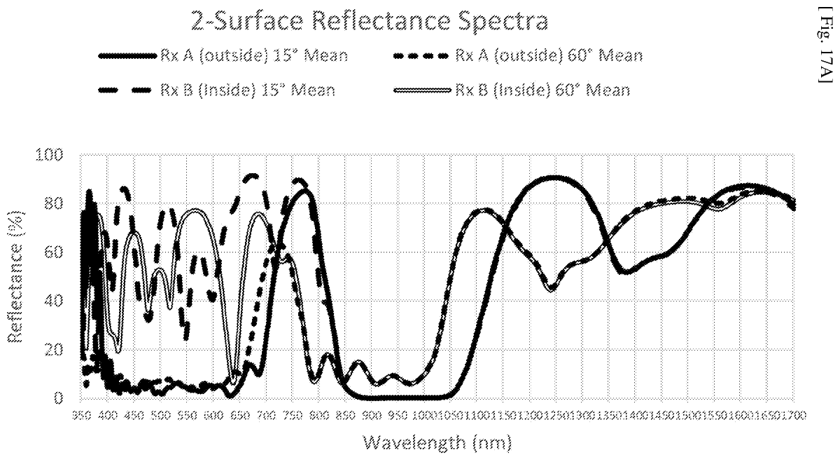

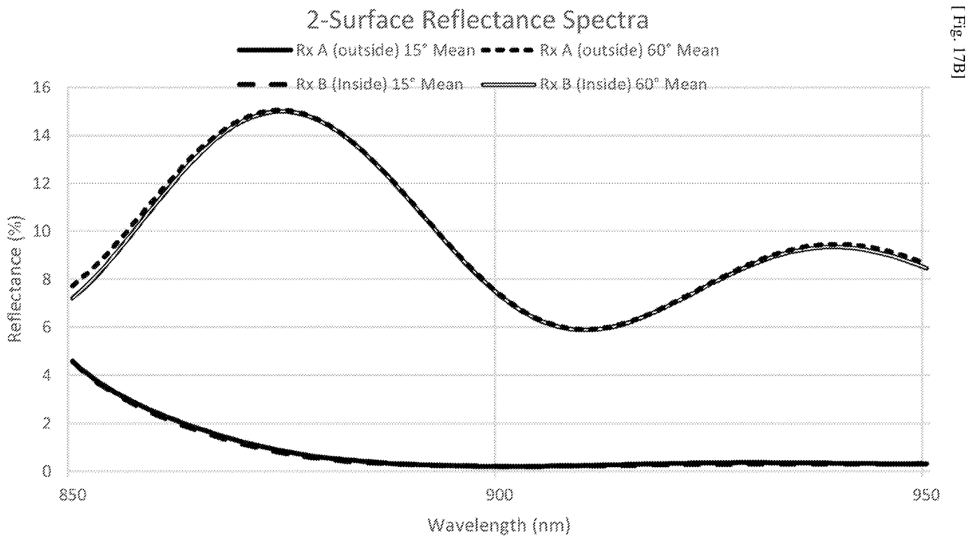

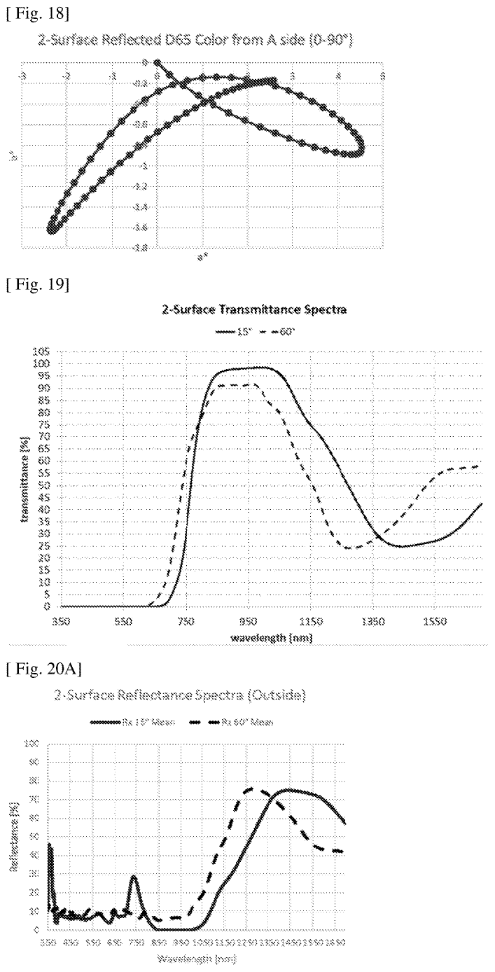

As revealed in FIG. 18, the quantity, thicknesses, number, and materials of the first layered film 36 and the second layered film 38 have been configured so that the window 24 of Example 3 has a dark appearance when viewed from the terminal surface 44 of the first layered film. FIG. 18 provides simulated CIELAB reflected color data for Example 3 for light reflected off of the terminal surface 44. The CIELAB a* and b* values were generated by simulating an illuminant source at a plurality of different angles of incidence, ranging from 0° to 90°. As shown, the a* values ranges from about −2.3 to about 4.5, while the b* values ranges from about −1.65 to about 0. This indicates that the window 24 according to Example 3 has a neutral appearance when viewed form the external environment 26 (see FIG. 1). The windows according to Examples 2 and 3 also exhibited an L* value of less than 26 for light incident on the terminal surface 44 at an angle of incidence ranging from 0° to 45°, thereby facilitating a perceived darkness of the window 24 at those viewing angles.

Alternative embodiments can be formed by modifying Example 3 by increasing the number of silicon layers in the second layered film 38 and reducing the relative number of layers in the inner AR stack. These changes can beneficially flat out the reflectance spectra from the side of the terminal surface 44 as compared with Example 3, while still exhibiting the low reflectance from light incident on the terminal surface 48. Particularly, it has been found that providing at least 10 (e.g., 10, 11, 12, 13, 14, or even 15) Si layers in the second layered film while reducing the size of the inner AR stack to include less than 3 (i.e., 1 or 2) of the layers of the higher refractive index materials 40 between the Si layers and the TCO layer beneficially leads to a flatter reflection spectrum around the 50 nm wavelength range of interest. Such a flatter reflection spectrum beneficially increases manufacturing tolerances and provides greater production throughput when achieving the high transmittance and low reflectance performance at the 50 nm wavelength range of interest described herein. Windows including this greater number of silicon layers and reduced inner AR stacks can achieve a reflectance range (max−min) of less than 0.05% for light over a wavelength range from 850 nm to 970 nm that is incident on the terminal surface 44 at an angle of incidence of 15°. Such embodiments can also achieve a reflectance range (max−min) of less than 3% for light over a wavelength range from 850 nm to 950 nm that is incident on the terminal surface 44 at an angle of incidence of 60°.

Example 4—the window 24 of Example 4 included a first layered film 36 and a second layered film 38. The second layered film 38 included layers of a silicon material described as the “Low k” material herein. The window 24 of Example 4 included a first layered film 36 over a first surface 32 of a substrate 30. The window 24 also included a second layered film 38 over a second surface 34 of the substrate 30. In Example 4, the substrate 30 was the same construction as the Example 3.

The first layered film 36 included twenty-seven (27) alternating layers of SiO₂ as the lower refractive index material 42 and SiN as the higher refractive index material 40. Layer 20 was the scratch resistant layer of the higher refractive index material 40, having a thickness of 2055.93 nm. Layers 1-19 were optical control layers having a combined thickness of 1108.71 nm separating the scratch resistant layer from the terminal surface 44. Layers 21-27 were index matching layers separating the scratch resistance layer from the first surface 32 and having a combined thickness of 222.41 nm. In this example, the scratch resistant layer constituted 60.7% of the thickness of the first layered film 36.

The second layered film 38 included thirty-three (33) alternating layers of the lower refractive index material 42 and the higher refractive index material 40. In this example, the lower refractive index material 42 was SiO₂, while the higher refractive index material 40 was a combination of SiN, Si, and ITO. As shown, layers 29 and 31—the two closest layers of the higher refractive index material 40 to the substrate 30—were SiN. Layers 33, 35, 37, 39, 41, 43, 45, 47, 49, 41, 43, and 55 where silicon layers. The Example 4 thus contains a greater number of silicon layers than the Example 3. Layer 33—the Si layer most proximate to the substrate 30—was the narrowest Si layer, with a thickness of 8.05 nm. The combined thickness of the silicon layers was 522.03 nm, which constituted 31.7% of the total thickness of the second layered film 38. As such, compared to the Example 3, the Example 4 contained a greater number of silicon layers. While the combined thickness of the silicon layers was less in Example 4 than in the Example 3, the combined thickness constituted a greater percentage of the overall thickness of the second layered film (more than 30%). Layer 59 was a layer of TCO material. As shown, the TCO layer had a refractive index of 1.54. The TCO was beneficially located rearward (closer to the terminal surface 48) than the silicon layers.

In Example 4, layers 56-58 separate the silicon layers from the TCO layer and represent an inner AR stack, with the inner AR stack including SiN as the higher refractive index material. As shown, one SiN layer separates the innermost silicon layer from the terminal surface 48. The inner AR stack included three layers with a combined thickness of 109.28 nm, representing 6.62% of the total thickness of the second layered film 38. Thus, the inner AR stack was much smaller in the Example 4 as compared to the Example 3, and made up much less of a portion of the entire thickness (less than 10%) of the second layered film 38. Moreover, the inner AR stack in the Example 4 included two relatively thin SiO₂ layers (layers 56 and 58), with thicknesses of 10 nm and 20 nm, respectively. Without wishing to be bound by theory, the thinner inner AR stack in Example 4 were compensated through the additional Si layers, which facilitated achieving favorable reflectance performance for light off the terminal surface 48.

The thicknesses of the layers of the first layered film 36 and the second layered film 38 in Example 4 were configured as set forth in Table 4 below and used to calculate the transmittance, reflectance, CIELAB color space and lightness values set forth in FIGS. 19-21.

TABLE 4
Example 4 Layer Design

| | | Refractive | Physical |
|---|---|---|---|
| | | Index | Thickness |
| Layer | Material | @905 nm | (nm) |
| Medium | Air | 1 | |
| | Perfluoropolyether | 1-4 | 4-8 |
| 1 | SiO2 | 1.46757 | 123.09 |
| 2 | SiN | 2.01527 | 21.51 |
| 3 | SiO2 | 1.46757 | 16.32 |
| 4 | SiN | 2.01527 | 104.99 |
| 5 | SiO2 | 1.46757 | 27.08 |
| 6 | SiN | 2.01527 | 15.97 |
| 7 | SiO2 | 1.46757 | 174.33 |
| 8 | SiN | 2.01527 | 13.57 |
| 9 | SiO2 | 1.46757 | 36.02 |
| 10 | SiN | 2.01527 | 29.66 |
| 11 | SiO2 | 1.46757 | 12.41 |
| 12 | SiN | 2.01527 | 126.56 |
| 13 | SiO2 | 1.46757 | 28.18 |
| 14 | SiN | 2.01527 | 23.88 |
| 15 | SiO2 | 1.46757 | 232.35 |
| 16 | SiN | 2.01527 | 18.99 |
| 17 | SiO2 | 1.46757 | 46.96 |
| 18 | SiN | 2.01527 | 40.33 |
| 19 | SiO2 | 1.46757 | 16.51 |
| 20 | SiN | 2.01527 | 2055.93 |
| 21 | SiO2 | 1.46757 | 14.01 |
| 22 | SiN | 2.01527 | 45.65 |
| 23 | SiO2 | 1.46757 | 36.81 |
| 24 | SiN | 2.01527 | 28.78 |
| 25 | SiO2 | 1.46757 | 59.65 |
| 26 | SiN | 2.01527 | 12.51 |
| 27 | SiO2 | 1.46757 | 25 |
| Substrate | Aluminosilicate glass (2320) | 1.4985 | 2850000.0 |
| Substrate | Aluminosilicate glass (2320) | 1.4985 | 1000000.0 |
| 28 | SiO2 | 1.46757 | 25 |
| 29 | SiN | 2.01527 | 13.59 |
| 30 | SiO2 | 1.46757 | 64 |
| 31 | SiN | 2.01527 | 29.18 |
| 32 | SiO2 | 1.46757 | 36.42 |
| 33 | Si | 3.67482 | 8.05 |
| 34 | SiO2 | 1.46757 | 44.05 |
| 35 | Si | 3.67482 | 21.35 |
| 36 | SiO2 | 1.46757 | 29.05 |
| 37 | Si | 3.67482 | 43.66 |
| 38 | SiO2 | 1.46757 | 18.88 |
| 39 | Si | 3.67482 | 45.69 |
| 40 | SiO2 | 1.46757 | 18.25 |
| 41 | Si | 3.67482 | 125.32 |
| 42 | SiO2 | 1.46757 | 35.34 |
| 43 | Si | 3.67482 | 28.38 |
| 44 | SiO2 | 1.46757 | 49.14 |
| 45 | Si | 3.67482 | 130.47 |
| 46 | SiO2 | 1.46757 | 62.61 |
| 47 | Si | 3.67482 | 22.6 |
| 48 | SiO2 | 1.46757 | 80.51 |
| 49 | Si | 3.67482 | 41.62 |
| 50 | SiO2 | 1.46757 | 59.92 |
| 51 | Si | 3.67482 | 31.43 |
| 52 | SiO2 | 1.46757 | 165.16 |
| 53 | Si | 3.67482 | 10.83 |
| 54 | SiO2 | 1.46757 | 139.6 |
| 55 | Si | 3.67482 | 12.63 |
| 56 | SiO2 | 1.46757 | 10 |
| 57 | SiN | 2.01527 | 79.28 |
| 58 | SiO2 | 1.46757 | 20 |
| 59 | ITO | 1.54307 | 22 |
| 60 | SiO2 | 1.46757 | 124.32 |
| Medium | Air | 1 | |

FIG. 19 is a plot of a modelled transmittance (polarization-averaged) of the window 24 according to Example 4 for light that is incident on the window 24 at a 15° angle of incidence and a 60° angle of incidence throughout the spectral range of 350 nm to 1600 nm. As revealed in FIG. 19, the quantity, thicknesses, number, and materials of the first layered film 36 and the second layered film 38 have been configured so that the window 24 of Example 4 has a percentage transmittance of above 95 percent for light incident on the first surface 32 or the second surface 34 at angles of incidence of less than 15° throughout a wavelength range extending from 850 nm to 950 nm. Indeed, throughout the wavelength range of 850 nm to 950 nm, the window exhibits a transmittance of greater than 95% for light at a 15° angle of incidence.

Additionally, as shown in FIG. 19, the quantity, thicknesses, number, and materials of the first layered film 36 and the second layered film 38 have been configured so that the window 24 of Example 4 has a polarization-averaged transmittance, calculated over a wavelength range of interest from 850 nm to 950 nm, of greater than 90% for light incident on the first surface and the second surface at angles within 60° of normal to the first surface and the second surface. Further, as revealed in FIG. 19, the quantity, thicknesses, number, and materials of the first layered film 36 and the second layered film 38 have been configured so that the window 24 of Example 4 has a transmittance less than 20% throughout the visible spectrum for light incident on the window 24 (the terminal surface 44) at angles of incidence of less than or equal to 60°. At 60° angle of incidence on the terminal surface 44, the window 24 according to Example 4 exhibits a transmittance that is less than 0.1% throughout the wavelength range from 400 nm to 600 nm. The window 24 according to Example 4 exhibits an average transmittance of less than 1% from 400 nm to 700 nm at both normal and a 15° angle of incidence.

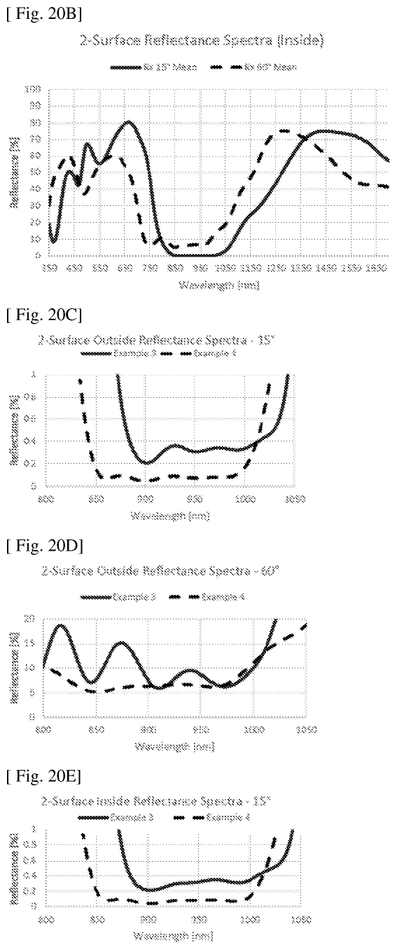

As revealed in FIG. 20A, the quantity, thicknesses, number, and materials of the first layered film 36 and the second layered film 38 have been configured so that the window 24 of Example 4 has a polarization-averaged percentage reflectance off of the terminal surface 44 of the first layered film 36 of under 1% for light incident on the substrate 30 at an angle of incidence of 15° within the approximate wavelength range of 850 nm to 950 nm. As is revealed in FIG. 20B, the quantity, thicknesses, number, and materials of the first layered film 36 and the second layered film 38 have been configured so that the window 24 of Example 4 has an average percentage reflectance off of the terminal surface 48 of the second layered film 38 of under 0.5% for light incident at an angle of incidence of 15° within the approximate wavelength range of 850 nm to 950 nm (polarizations averaged). The window 24 of Example 4 exhibits a polarization averaged reflectance of less than 10% for light within the approximate wavelength range of 850 nm to 950 nm and incident on either of the terminal surfaces 44 and 48 at a 60° angle of incidence.

FIGS. 20C, 20D, and 20E compare the reflectance performances over the wavelength range of 850 nm to 950 nm of the windows according to Example 3 and Example 4. FIGS. 20C and 20D are plots of polarization averaged reflectance for light incident on the terminal surfaces 44 of Examples 3 and 4 at 15° and 60° angles of incidence, respectively. As is revealed in FIG. 20C, the reconfiguration of the second layered film 38 in Example 4 provided lower reflectance (of under 0.1%) at a 15° angle of incidence throughout the wavelength range from 860 nm to 950 nm. The reflectance range (max-min) was also less than 0.05% for Example 4 for the 850 nm to 950 nm wavelength range, whereas Example 3 exhibited a range of almost 0.2%. As is revealed in FIG. 20D, the reconfiguration of the second layered film 38 in Example 4 provided lower reflectance (of under 7%) at a 60° angle of incidence throughout the wavelength range from 850 nm to 950 nm. The reflectance range (max-min) was also less than 3% for Example 4 for the 850 nm to 950 nm wavelength range, whereas Example 3 exhibited a range of more than 5%. As is revealed in FIG. 20E, the reconfiguration of the second layered film 38 in Example 4 provided lower reflectance (of under 0.2%) for light incident on the terminal surface 48 at a 15° angle of incidence throughout the wavelength range from 850 nm to 950 nm. These results demonstrate both reduced reflectance and a flatter reflectance spectra throughout the 850 nm to 950 nm wavelength range of Example 4 as compared to Example 3. As described herein, render the layered films more easier to manufacture.

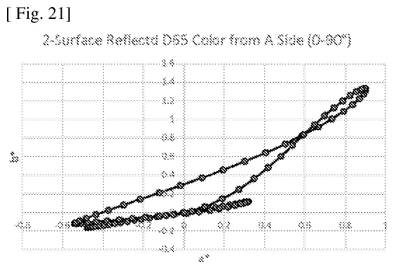

As revealed in FIG. 21, the quantity, thicknesses, number, and materials of the first layered film 36 and the second layered film 38 have been configured so that the window 24 of Example 4 has a dark appearance when viewed from the terminal surface 44 of the first layered film. FIG. 21 provides simulated CIELAB reflected color data for Example E for light reflected off of the terminal surface 44. The CIELAB a* and b* values were generated by simulating an illuminant source at a plurality of different angles of incidence, ranging from 0° to 90°. As shown, the a* values ranges from about −0.58 to about 0.9, while the b* values ranges from about −0.2 to about 1.4. This indicates that the window 24 according to Example 4 has a neutral appearance when viewed form the external environment 26 (see FIG. 1). The windows according to Examples 2 and 3 also exhibited an L* value of less than 37 for light incident on the terminal surface 44 at an angle of incidence ranging from 0° to 60°, thereby facilitating a perceived darkness of the window 24 at those viewing angles.

It will be apparent to those skilled in the art that various modifications and variations can be made without departing from the spirit or scope of the claims.

1. A window for a sensing system comprising:
a substrate comprising a first surface and a second surface, the first surface and the second surface being primary surfaces of the substrate;
a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film;
a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and
a maximum hardness, measured at the first layered film and by the Berkovich Indenter Hardness Test, of at least 8 GPa,
wherein the quantity, the thicknesses, number, and materials of the alternating layers of the first and second layered films are configured so that the window has:
an average percentage transmittance, calculated over a 50 nm wavelength range of interest centered at a wavelength between 850 nm and 950 nm, of greater than 90% for light incident on the first surface and the second surface at angles of incidence of less than or equal to 15°;
an average reflectance, calculated over the 50 nm wavelength range of interest between 850 nm and 950 nm, of less than 4% for light incident on the first surface and the second surface at angles of less than or equal to 15°; and
an average percentage transmission, calculated from 400 nm to 700 nm, of less than 5% for light incident on the first surface and the second surface at angles of incidence of less than or equal to 15°.

2. The window of claim 1, wherein the quantity, the thicknesses, number, and materials of the alternating layers of the first and second layered films are configured so that the window has an average P polarization transmittance and an average S polarization transmittance, calculated over the 50 nm wavelength range of interest, of greater than 85% for light incident on the first surface and the second surface at angles of incidence of less than or equal to 60°.

3. (canceled)

4. The window of claim 1, wherein the quantity, the thicknesses, number, and materials of the alternating layers of the first and second layered films are configured so that the window has a CIELAB L* value for reflection of less than or equal to 37 for angles of incidence of less than or equal to 60° on the first layered film.

5. (canceled)

6. The window of claim 1, wherein the quantity, the thicknesses, number, and materials of the alternating layers of the first and second layered films are configured so that the window has CIELAB a* and b* values for reflection of greater than or equal to −6.0 and less than or equal to 6.0 when viewed from a side of the first layered film.

7. (canceled)

8. The window of claim 1, wherein:
the refractive index of the substrate for electromagnetic radiation having a wavelength of 905 nm is from about 1.45 to about 1.55,
the substrate is a glass substrate or a glass-ceramic substrate,
the refractive index of the one or more higher refractive index materials is from about 1.7 to about 4.0, and wherein the refractive index of the one or more lower refractive index materials is from about 1.3 to about 1.6, and
a difference in the refractive index of any of the one or more higher refractive index materials and any of the one or more lower refractive index materials is about 0.5 or greater.

9. The window of claim 1, wherein:
one of the alternating layers of the first layered film that is farthest from the substrate forms a terminal surface material of the window, the terminal surface material of the window comprising the lower refractive index material, and
the first layered firm comprises a scratch resistant layer formed of one of the one or more higher refractive index materials and having a thickness of greater than or equal to 1500 nm and less than or equal to 5000 nm.

10. The window of claim 9, wherein the scratch resistant layer is separated from the terminal surface by a plurality of the alternating layers of the one or more lower index materials and the one or more higher index materials of the first layered film, and wherein the scratch resistant layer is separated from the terminal surface by at least 1000 nm.

11. (canceled)

12. The window of claim 1, wherein the one or more higher refractive index materials of the second layered film comprise silicon having an extinction coefficient of less than or equal to 0.01 over the 50 nm wavelength range of interest.

13. (canceled)

14. The window of claim 1, wherein the second layered film comprises a layer of TCO material and two or more silicon layers, and wherein the two or more silicon layers are disposed between the layer of TCO material and the substrate.

15. (canceled)

16. The window of claim 14, wherein the layer of TCO material comprises a thickness that is greater than or equal to 20 nm and less than or equal to 30 mm.

17. The window of claim 16, wherein the layer of TCO material is indium tin oxide and comprises an extinction coefficient that is less than or equal to 0.05 throughout the 50 nm wavelength range of interest.

18. The window of claim 14, wherein a silicon layer of the second layered film most proximate to the substrate comprises the smallest thickness of the two or more silicon layers.

19. The window of claim 18, wherein a combined thickness of the silicon layers contained in the second layered film is greater than or equal to 450 nm.

20. The window of claim 12, wherein a layer of the one or more higher refractive index materials in the second layered film is not silicon.

21. The window of claim 20, wherein an inner AR stack separates two or more silicon layers of the second layered film from an inner terminal surface of the second layered film, wherein the inner AR stack comprises at least one layer of the one or more higher refractive index materials that are not silicon.

22. The window of claim 21, wherein the quantity, the thicknesses, number, and materials of the alternating layers of the first and second layered films are configured so that the window has an average percentage reflectance, calculated over the 50 nm wavelength range of interest, of less than 0.5% for light incident on both a first terminal surface of the first layered film and a second terminal surface of the second layered film at angles of incidence of less than or equal to 15°.

23. The window of claim 21, wherein the quantity, the thicknesses, number, and materials of the alternating layers of the first and second layered films are configured so that the window has an average percentage transmittance, calculated from 400 nm to 700 nm, of less than 1% for light normally incident on the first surface and the second surface.

24. The window of claim 21, wherein:
the second layered film comprises at least ten silicon layers, and
the inner AR stack comprises less than two layers of the one or more higher refractive index materials that are not silicon.

25. The window of claim 24, wherein the quantity, the thicknesses, number, and materials of the alternating layers of the first and second layered films are configured so that the window exhibits a polarization averaged reflectance range (max-min) that is less than 0.5% for light that is incident on the first layered film at a 15° angle of incidence, calculated over the wavelength range from 850 nm to 950 nm.

26. (canceled)

27. The window of claim 1, wherein a hardness, measured at the first layered film and by the Berkovich Indenter Hardness Test, is at least 14 GPa over a depth range of 400 nm to 1000 nm.

28-49. (canceled)
